(19) United States
(12) Patent Application Publication
(10) Pub. No.: US 2026/0193490 A1
(43) Pub. Date: Jul. 9, 2026

(54) COATING COMPOSITION

(71) Applicant: The University of Melbourne, Melbourne, Victoria (AU)

(72) Inventors: Sandra KENTISH, Victoria (AU); Yidi LEI, Melbourne, Victoria (AU); Colin A. SCHOLES, Victoria (AU); Liang LIU, Queensland (AU); Karteek BOGA, Victoria (AU)

(21) Appl. No.: 19/133,204

(22) PCT Filed: Nov. 28, 2023
(86) PCT No.: PCT/AU2023/051220

§ 371 Date: May 27, 2025

(30) Foreign Application Priority Data
Nov. 28, 2022 (AU) 2022903595
May 25, 2023 (AU) 2023901637

(51) Int. Cl. C09D 187/00; C08G 81/02; C09D 5/04

(52) U.S. Cl. CPC C09D 187/005; C08G 81/025; C09D 5/04

(57) ABSTRACT

Disclosed is a coating composition for forming a hydrogen-barrier coating on a surface. The coating composition can comprise a crosslinked polyhydroxy polymer, said crosslinked polyhydroxy polymer obtained by reacting a polyhydroxy polymer with a hydroxyl-reactive crosslinking agent; and a carrier.

### REFERENCE TO EARLIER APPLICATIONS

The present application claims priority from Australian Provisional Patent Application Nos. 2022903595 and 2023901637, the entire contents of each of which are incorporated herein by reference.

### TECHNICAL FIELD

This disclosure relates to a coating composition for forming a hydrogen-barrier coating on a surface.

### BACKGROUND ART

Hydrogen embrittlement is a generally recognised effect occurring in metals of high strength, e.g. steel. It has been a recognised problem for the hydrogen industry for decades. The problem of hydrogen embrittlement is again receiving attention as there is a mounting imperative worldwide to decrease society's reliance on fossil fuels as a source of energy and move to renewable sources, such as hydrogen.

As part of society's transition to hydrogen, it is envisaged that the existing natural gas infrastructure will be used to transport blends of hydrogen and natural gas to consumers. However, most natural gas pipelines are constructed of metal, e.g. steel, and so the maximum amount of hydrogen that can be blended with natural gas must be limited, to minimise embrittlement of the pipelines.

A number of methods to prevent hydrogen embrittlement on steel have been developed. Typically, these methods aim to reduce the rate of hydrogen transmission into the steel, for example by coating the steel with a suitable material. In the past, methods including cadmium and nickel plating, black oxide conversion coating, hard coatings such as TiO₂ and hydrogen trapping techniques have been shown to at least reduce hydrogen embrittlement.

These prior art methods can have significant disadvantages. For example, the process of electroplating can itself introduce hydrogen into steel, resulting in embrittlement. This effect can be mitigated, but only with post heat treatment of the coated steel. Depending on the location of the steel to be coated, such heat treatment may not be feasible. For example, it may not be possible to heat treat coatings applied to existing underground pipelines. As an alternative, hydrogen barriers that use polymeric materials together with nanomaterials have been investigated. However, thin films are difficult to construct across large surface areas, so their applications are limited.

Some polymeric materials are known to have gas barrier properties but may not be suitable for use as a hydrogen-barrier. The small size of the hydrogen molecule results in the hydrogen permeating more readily through a polymeric material than other gases. In addition, due to their rheological characteristics, known gas-barrier polymers may not be suitable for use in coating compositions. For example, coatings formed using known gas-barrier polymers are often highly brittle. Alternatively, the coating composition may have low viscosities at both low shear rates and high shear rates making it difficult to apply on vertical surfaces.

To enable the transition to a hydrogen economy, coatings are required which can be easily applied to existing pipelines and which will minimise hydrogen embrittlement thereof.

### SUMMARY

Disclosed herein in a first aspect is a coating composition for forming a hydrogen-barrier coating on a surface. The hydrogen-barrier coating may be applied to a surface to decrease the amount of hydrogen to which the surface is exposed. For example, the hydrogen-barrier coating may be applied to a metallic substrate. The metallic substrate may comprise one or more intermediate coatings onto which the hydrogen-barrier coating is applied. Alternatively, the hydrogen-barrier coating may be applied directly to a metallic surface of the metallic substrate.

The coating composition can comprise a crosslinked polyhydroxy polymer. The crosslinked polyhydroxy polymer can be obtained by reacting a polyhydroxy polymer with a hydroxyl-reactive crosslinking agent. The coating composition can further comprise a carrier. The coating composition can exhibit shear-thinning behaviour.

For large scale infrastructure, and particularly for piping that is buried underground, suitable polymeric coatings and methods for their delivery are required. Ideally, the hydrogen-barrier coating is applied before hydrogen is transported within the piping, in order to reduce the risk of hydrogen embrittlement. For such infrastructure, it is advantageous if the coating materials can be readily applied as near-ambient temperature solutions with only very limited heating or other chemical treatments required to cure the coating. Additionally, due to the very large areas covered by such infrastructure, it may be advantageous for the method to be cost effective and performed without the use of expensive materials. Advantageously, by providing a polymer coating with shear-thinning behaviour, embodiments of the coating composition may be suitable for being applied to the surface using means which are conventionally used to apply coatings with shear-thinning behaviour (such as paints) to surfaces, for example, brushing or spraying. The surface may be any surface that may be exposed to hydrogen. For example, the surface can be part of an interior surface of a pipe through which hydrogen or a gas comprising hydrogen is to be transported. In these embodiments, the coating formed from the coating composition can be a suitable hydrogen-barrier under the conditions at which the gas comprising hydrogen is to be transported through the pipe. For example, the coating formed can be a suitable hydrogen-barrier under ambient temperature. Alternatively, the surface can be part of the interior surface of a storage vessel. For example, in some embodiments, the surface can be part of an underground ‘cavern’ (i.e. natural rock structure) in which gas compositions, such as natural gas, is stored. This may help to prevent gas loss.

In some embodiments of the first aspect, the shear-thinning behaviour is such that said coating composition has a first viscosity of about 10,000 mPa·s to about 100,000 mPa·s under a shear rate of about 0.1 s⁻¹, and a second viscosity of less than 1,000 mPa·s under a shear rate of about 10,000 s⁻¹. Shear rates of about 0.1 s⁻¹ or less are generally referred to herein as the low shear rate region, whilst shear rates of about 5000 s⁻¹ or more are generally referred to herein as the high shear rate region. Advantageously, viscosities of less than about 1,000 mPa·s in the high shear rate region may enable the coating composition to be applied to the surface by brushing and/or spraying, whilst a viscosity of about 10,000 mPa·s to about 100,000 mPa·s in the low shear rate region may reduce the propensity of the coating to drip and/or run once applied to a vertical surface.

In some embodiments of the first aspect, the polyhydroxy polymer is selected from the group consisting of: partially hydrolysed poly(vinyl alcohol); fully hydrolysed poly(vinyl alcohol); and poly(vinyl alcohol) copolymer.

In some embodiments of the first aspect, the polyhydroxy polymer has a number average molecular weight (Mₙ) of about 30,000 g/mol to about 500,000 g/mol.

In some embodiments of the first aspect, the hydroxyl-reactive crosslinking agent is a diepoxide crosslinking agent. For example, the diepoxide crosslinking agent can be vinylcyclohexene dioxide, butadiene dioxide, or a diglycidyl ether. The diglycidyl ether can be selected from the group consisting of glycerol diglycidyl ether, 1,4-butanediol diglycidyl ether, ethylene glycol diglycidyl ether (EGDGE), isosorbide diglycidyl ether and poly(ethylene glycol) diglycidyl ether (PEGDGE). When the hydroxyl-reactive crosslinking agent is a diglycidyl ether, the diglycidyl ether typically has a molecular weight of about 174 g/mol to about 6000 g/mol.

In some embodiments of the first aspect, the molar ratio of the hydroxyl groups in the polyhydroxy polymer to the hydroxyl-reactive crosslinking agent is about 50:1 to 5:1, such as about 30:1 to about 10:1. In these embodiments, the hydroxyl-reactive crosslinking agent typically comprises two reactive groups. In this regard, it will be understood that, in these embodiments the molar ratio of the hydroxyl groups in the polyhydroxy polymer to the hydroxyl-reactive groups of the crosslinking agent is about 50:2 to about 5:2. That is, because for every mole of hydroxyl-reactive crosslinking agent, there are two moles of reactive groups.

In some embodiments of the first aspect, the carrier is selected from the group consisting of water and ethanol.

In some embodiments of the first aspect, the crosslinked polyhydroxy polymer comprises less than about 20% by weight of the coating composition.

Disclosed herein in a second aspect is a hydrogen-barrier coating formed from the coating composition of the first aspect. The hydrogen-barrier coating may be applied to a surface to reduce the amount of hydrogen that is able to diffuse into the surface.

In some embodiments of the second aspect, the hydrogen-barrier coating has a hydrogen gas permeability of less than about 0.04 Barrer, such as less than about 0.01 Barrer. That is, the hydrogen-barrier coating may not be completely impermeable to hydrogen. However, the hydrogen-barrier coating can advantageously reduce the amount of hydrogen that contacts the surface onto which it is coated. Barrer is a non-SI unit of gas permeability commonly used in the membrane technology industry. In SI units, 1 Barrer is equivalent to 3.35×10⁻¹⁶ mol·m·m⁻²·s⁻¹·Pa⁻¹.

In some embodiments of the second aspect, the hydrogen-barrier coating has a dry thickness of about 0.03 mm to about 2 mm, for example the dry thickness may be about 0.10 mm. As used herein, “dry” refers to when the coating has been applied to a surface and sufficient carrier has been removed from the applied coating such that a consolidated film is formed, rather than the “wet” layer of freshly applied coating composition. The thickness of a freshly applied layer of coating composition (a “wet” layer) may be about 0.1 mm to about 10 mm, such as about 5 mm or about 2 mm. In some embodiments, the wet layer thickness may be from about 0.2 mm to about 0.5 mm (200-500 microns).

In some embodiments of the second aspect, said hydrogen-barrier coating is on a surface. For example, the surface can be part of an interior surface of a pipe through which hydrogen or a gas comprising hydrogen is to be transported; or the interior surface of a storage vessel. Thus, the surface the hydrogen-barrier coating is on can comprise a metallic surface, for example when the pipe or storage vessel is constructed of metal. The hydrogen-barrier coating may be directly on the metallic surface. Alternatively, the metallic surface may comprise one or more primer coats or other coatings, with the hydrogen-barrier coating applied thereto. Suitable primer coatings may include coatings employed to reduce friction and improve flow efficiency through pipelines, such coatings are sometimes known as a ‘flow coatings’ or ‘flowcoats’.

In some embodiments of the second aspect, applying the coating comprises applying multiple layers of the coating to the surface, permitting each layer to dry before a next layer is applied, so as to achieve a desired thickness.

Disclosed herein in a third aspect is a method for preventing or reducing exposure of a surface to hydrogen from a hydrogen gas-containing environment.

The method can comprise applying the coating composition of the first aspect to the surface; and drying said coating composition to form a hydrogen-barrier coating, wherein the hydrogen-barrier coating prevents or reduces exposure of the surface to hydrogen from the hydrogen gas-containing environment.

In some embodiments of the third aspect, the surface is a metallic surface. For example, the surface can be part of an interior surface of a pipe.

In a fourth aspect, the coating composition for forming a hydrogen-barrier coating on a metallic surface is provided, said coating composition comprising: a crosslinked poly(vinyl alcohol) polymer, said crosslinked poly(vinyl alcohol) polymer obtained by reacting a poly(vinyl alcohol) polymer with a diepoxide crosslinking agent; and a carrier.

In some embodiments of the fourth aspect, the poly(vinyl alcohol) polymer is selected from the group consisting of: partially hydrolysed poly(vinyl alcohol); fully hydrolysed poly(vinyl alcohol); and poly(vinyl alcohol) copolymer.

In some embodiments of the fourth aspect, the poly(vinyl alcohol) polymer has a number average molecular weight (Mn) of about 30,000 g/mol to about 200,000 g/mol.

The diepoxide crosslinking agent may be vinylcyclohexene dioxide, butadiene dioxide, or a diglycidyl ether. In some embodiments of the fourth aspect, the diglycidyl ether is selected from the group consisting of glycerol diglycidyl ether, 1,4-butanediol diglycidyl ether, ethylene glycol diglycidyl ether (EGDGE), isosorbide diglycidyl ether and poly(ethylene glycol) diglycidyl ether (PEGDGE). The diglycidyl ether may have a molecular weight of about 174 g/mol to about 6000 g/mol.

In some embodiments of the fourth aspect, the molar ratio of the hydroxyl groups in the poly(vinyl alcohol) polymer to the diepoxide crosslinking agent is about 50:1 to 5:1. The diepoxide crosslinking agent typically comprises two reactive groups such that, for every mole of diepoxide crosslinking agent, there are two moles of reactive groups. In this regard, it will be understood that, in these embodiments, the molar ratio of the hydroxyl groups in the polyhydroxy polymer to the reactive groups of the diepoxide crosslinking agent is about 50:2 to about 5:2.

The carrier may be selected from the group consisting of water and ethanol. In some embodiments, the crosslinked poly(vinyl alcohol) polymer comprises less than about 20% by weight of the coating composition.

A fifth aspect provides a hydrogen-barrier coating formed from the coating composition according to the fourth aspect. The hydrogen-barrier coating may have a hydrogen gas permeability of less than about 0.04 Barrer, for example less than about 0.01 Barrer. The hydrogen-barrier coating may have a dry film thickness of about 0.03 mm to about 2 mm, for example about 1 mm or about 0.1 mm (100 μm). The hydrogen-barrier coating may be provided on a surface, such as part of an interior surface of a pipe.

A sixth aspect provides a method for preventing or reducing exposure of a surface to hydrogen from a hydrogen gas-containing environment, said method comprising: applying the coating composition according to the fourth aspect to the surface; and drying said coating composition to form a hydrogen-barrier coating, wherein the hydrogen-barrier coating prevents or reduces exposure of the surface to hydrogen from the hydrogen gas-containing environment. Applying the coating may comprise applying multiple layers of the coating to the surface, permitting each layer to dry before a next layer is applied, so as to achieve a desired thickness. Applying the coating may also comprise applying one or more primer layers to the surface prior to applying the coating composition. The one or more primer layers may, for example, promote adhesion between the coating composition and the pipe surface.

A seventh aspect provides a precursor composition for forming a coating composition, said precursor composition comprising: a poly(vinyl alcohol) polymer; a diepoxide crosslinking agent; and a carrier. The precursor composition may be a blend comprising a poly(vinyl alcohol) polymer; a diepoxide crosslinking agent; and a carrier. The seventh aspect can provide a precursor composition suitable for forming a coating composition in accordance with the first and/or fourth aspects described above. For example, the poly(vinyl alcohol) polymer may be selected from the group consisting of: partially hydrolysed poly(vinyl alcohol); fully hydrolysed poly(vinyl alcohol); and poly(vinyl alcohol) copolymer. The diepoxide crosslinking agent may be a diglycidyl ether selected from the group consisting of glycerol diglycidyl ether, 1,4-butanediol diglycidyl ether, ethylene glycol diglycidyl ether (EGDGE), isosorbide diglycidyl ether and poly(ethylene glycol) diglycidyl ether (PEGDGE).

In some embodiments of the seventh aspect, the precursor composition may further comprise a catalyst.

Use of a precursor composition of the seventh aspect to form a coating composition in accordance with the first and/or fourth aspects is also provided. For example, the precursor composition of the seventh aspect may be used to form the coating composition of the fourth aspect. The coating composition of the fourth aspect may be formed by allowing crosslinking of the poly(vinyl alcohol) polymer by the diepoxide crosslinking agent within the precursor composition.

### BRIEF DESCRIPTION OF THE DRAWINGS

Embodiments will now be described by way of example only, with reference to the accompanying drawings in which:

FIGS. 1A and 1B are block flow diagrams of different embodiments of a method for producing a crosslinked polyhydroxy polymer and applying it to a surface as a hydrogen-barrier coating.

FIG. 2 is a plot of the hydrogen permeability (bars) and crystallinity (symbols) for crosslinked polyhydroxy polymers containing PVA/PEGDGE.

FIG. 3 is a plot of the viscosity as a function of the shear rate for a PEGDGE solution and a solution comprising 10 wt. % PVA.

FIG. 4 is a plot showing the relationship between shear stress and shear rate for different coatings.

FIGS. 5A and 5B are plots showing the relationship between viscosity and shear rate for coatings produced under different conditions, and FIG. 5C is a plot comparing the shear-thinning behaviour of two coatings.

FIGS. 6A and 6B are plots showing the relationship between shear stress and shear rate for a PVA/PEGDGE crosslinked polymer in which the ratio of the moles of hydroxyl groups in the PVA to moles of PEGDGE is 30:1 and for a PVA/PEGDGE crosslinked polymer in which said molar ratio is 20:1 respectively.

FIG. 7 is a cross-sectional view of a steel pipe with a polymer coating film.

FIGS. 8A and 8B are XRD diffractograms of, respectively, PVA and a PVA/PEGDGE crosslinked polymer in which the ratio of the moles of hydroxyl groups in the PVA to the moles of PEGDGE is 30:1.

FIGS. 9A and 9B are plots showing the relationship between viscosity and shear rate for coatings produced under different conditions and using PVA with a molecular weight of 89,000-98,000 g/mol.

FIGS. 10A and 10B are plots showing the relationship between viscosity and shear rate for coatings produced using a PEGDGE crosslinker with different molecular weights.

FIGS. 11A and 11B are plots showing the relationship between viscosity and shear rate for coatings produced using, respectively, NaOH and triethyl amine catalysts.

FIGS. 12A and 12B are plots showing the relationship between viscosity and shear rate for coatings produced using, respectively, NaOH and NH₄OH catalysts in which the final PVA concentration of the coating composition was 10 wt. %.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

Unless defined otherwise, all technical and scientific terms used herein have the same meaning as commonly understood by those of ordinary skill in the art of the invention. Although any methods and materials similar or equivalent to those described herein can be used in the practice or testing of the present invention, preferred methods and materials are described. For the purposes of the present invention, a number of terms are defined throughout.

The present disclosure is directed to a coating composition for forming a hydrogen-barrier coating on a surface. For example, the surface may be a metallic surface, such as the interior of a pipe. However, the surface may also be a non-metallic surface that is in contact with hydrogen or a gas comprising hydrogen.

The coating composition comprises a crosslinked polyhydroxy polymer obtained by reacting a polyhydroxy polymer with a hydroxyl-reactive crosslinking agent and a carrier. Advantageously, the coating composition of the first aspect of the present disclosure exhibits shear-thinning behaviour.

On a surface, such as a steel surface, hydrogen molecules dissociate into hydrogen atoms and diffuse into the surface as singular atoms. These hydrogen atoms will first fill defects and the spaces between the grains within the steel, known as hydrogen traps. The initial diffusion coefficient (defined by the apparent diffusion coefficient) is low as these traps are filled. However, after extended exposure, these hydrogen traps are filled and the diffusion coefficient increases to a steady state value (the lattice diffusion coefficient). As hydrogen diffuses into the steel, it can embrittle the steel, leading to failure thereof.

The total concentration of the hydrogen atoms in steel is dependent on the solubility of hydrogen atoms in the surface (e.g. steel) and the partial pressure of hydrogen molecules (Sievert's law).

An example of a hydrogen concentration profile of a steel surface with a coating is depicted in FIG. 7. In FIG. 7, the pipe 200 comprises a polymer film coating 202 on a steel surface 204. The thickness 206 of the film coating 202 is less than the thickness 208 of the steel 204. The partial pressure of hydrogen 210 at the surface of the film coating is higher than the partial pressure of hydrogen 212 at the film coating-steel interface, which in turn is higher than the partial pressure of hydrogen 214 inside the steel 204. That is, the partial pressure of hydrogen 212 progressively decreases.

As will be appreciated, the flux of hydrogen through the steel 204 is governed by Fick's law and the permeability of hydrogen through the steel 204 is dependent on the apparent diffusion coefficient and the solubility of hydrogen atoms in the steel. With regard to the polymer film 202, the hydrogen concentration in the polymer film 202 is dependent on the solubility coefficient of hydrogen through the film and the partial pressure of hydrogen molecules.

The flux of hydrogen across the coating film 202 and the steel 204 should be identical for one coated steel specimen. Unlike steel, hydrogen permeates through polymer coatings in the form of hydrogen molecules. Thus, the flux of hydrogen atoms into the steel 204 will be double the flux of hydrogen molecules through the polymer film 202. In turn, the flux of hydrogen per unit pressure driving force is determined by the permeance, with the permeance being the ratio of the hydrogen permeability to the film thickness.

The permeability reduction factor (PRF) is the steady-state ratio of the permeation rate through the uncoated steel versus the permeation rate through the coated steel. The PRF can be used to show the quality of a coating in reducing embrittlement. Typically, a PRF of at least 10 is advantageous in reducing embrittlement.

There are different methods available by which the steady-state hydrogen permeability of steel can be estimated. It has been found that, based on the different assumptions invoked, the values for permeability can vary by up to three orders of magnitude.

Based on the above, it has been estimated that the hydrogen permeability required to reduce the hydrogen flux through a pipeline operating at a pressure of 10,000 kPa by ten-fold (i.e. corresponding to a PRF of 10) is between about 0.18 Barrer to about 0.000086 Barrer, for a coating of 1 mm dry film thickness applied to a steel pipe of 10 mm wall thickness. That is, a coating having a permeability of lower than about 0.18 Barrer can provide significant protection against hydrogen embrittlement.

As used herein, a “hydrogen-barrier coating” is a coating which acts to reduce the amount of hydrogen that is able to contact the surface onto which the hydrogen-barrier coating is applied. Thus, the hydrogen-barrier coating decreases the amount of hydrogen that can diffuse into the underlying surface. That is, some hydrogen may still diffuse through the coating and into the underlying surface because the hydrogen-barrier coating may not be completely impermeable to hydrogen. However, the amount of hydrogen contacting the surface and diffusing thereinto is reduced by the presence of the hydrogen-barrier coating.

As will be explained in greater detail below, the degree to which hydrogen is able to permeate the hydrogen-barrier coating is dependent on the properties of the coating.

### Crystallinity

Without wishing to be bound by theory, it is postulated that the ability of polyhydroxy polymers to act as a hydrogen-barrier is due to their susceptibility to form materials with regions of bulk crystallinity. That is, polyhydroxy polymers contain a fraction of ordered polymer chains within their bulk structure. For example, PVA polymers form a semi-crystalline bulk structure owing to the hydroxyl groups present within the PVA chains which can form folded and compacted crystalline regions. This occurs due to the presence of inter-molecular and intra-molecular hydrogen bonds. A similar phenomenon can occur with other polyhydroxy polymers, that is the hydroxyl groups present can form folded and compacted crystalline regions due to the formation of inter-molecular and intra-molecular hydrogen bonding.

The crystallinity of a material is characterised using x-ray diffraction (XRD). The degree of crystallinity of a sample may be ascertained as a percentage (%) based on the mass ratio of the bulk crystalline regions to the amorphous regions. The mass ratio of the bulk crystalline regions can be calculated using the intensity of the known peaks in a diffractogram. This is because diffractograms produced by amorphous components of the material do not produce any sharp diffraction peaks, i.e. because the amorphous material does not diffract x-rays. The methodology used to quantify the degree of crystallinity is described in further detail below with reference to Example 1.

Typically, crystalline regions of a polymer can be impermeable to most gases. In this regard, it has been found that the hydrogen permeability of a polyhydroxy polymer can be decreased by increasing the amount of crystallinity present in the polyhydroxy polymer coating. This is because the presence of the crystalline regions increases the diffusion path of hydrogen molecules, thus reducing the permeability thereof.

It is noted that the hydrogen permeabilities exhibited by polyhydroxy polymers formulated according to embodiments of the present invention, such as PVA, are up to an order of magnitude lower than hydrogen permeabilities of coatings of the prior art, such as epoxy coatings. To maintain good hydrogen permeability properties, the polyhydroxy polymer coating may have a crystallinity of at least about 70%, for example a crystallinity of about 90%.

An un-crosslinked PVA polymer (i.e. composed of PVA monomeric units only) with a crystallinity of about 83% may have a hydrogen permeability in the range of 0.01 Barrer to 0.02 Barrer, such as about 0.015 Barrer.

The thickness of the coating provided using the coating composition of the present disclosure may be selected based on the unit permeability or crystallinity provided by the coating composition. For a coating composition providing a coating with a relatively lower crystallinity, the minimum thickness of the coating may be selected to be higher than a coating composition that provides a coating with a greater crystallinity. By increasing the thickness of a hydrogen-barrier coating, for the same permeability, hydrogen will take longer to diffuse through a thicker coating compared to a thinner coating. In this way, increases in hydrogen permeability with lower crystallinity may be offset by increasing the thickness of the hydrogen-barrier coating formed using the coating composition.

### Applicability to Coatings

It is advantageous to be able to apply the hydrogen-barrier coating to a surface using means known in the art by which shear-thinning coatings, such as paint, are applied, for example spraying, brushing etc. Given the location and nature of surfaces such as gas pipelines, e.g. buried deep underground, the hydrogen-barrier coating can ideally be able to be applied with relative ease and without the need for specialised technology.

The coating compositions of the first aspect of the present disclosure exhibit shear-thinning rheological properties.

Shear-thinning substances have a low viscosity at a high shear rate, which means they can be easily applied to surfaces by brushing, spraying or other conventional means known in the art. However, at a low shear rate, shear-thinning substances have a high viscosity. This means that, once the substance is applied as a coating onto a surface, the substance will not readily flow down the surface, e.g. due to gravity. Shear-thinning rheological properties are desirable because they allow for consistent application across inclined and vertical surfaces, while minimising dripping and sagging once applied.

The coating composition of some embodiments of the present invention has a viscosity (at 25° C.) of about 10,000 mPa·s to about 100,000 mPa·s under a shear rate of about 0.1 s⁻¹ and a viscosity of less than about 1000 mPa·s under a shear rate of about 10,000 s⁻¹. In the high and low shear rate regions, the coating composition may thus exhibit similar viscosities to commercially available pipeline coatings for external use. The rheology of the coating composition is characterised using, for example, a MCR702 TwinDrive Rheometer (Anton Paar), as will be described in further detail in Example 1.

Those skilled will appreciate from the present disclosure that the shear-thinning rheological properties of the coating composition may be modified or selected according to the desired method of applying the composition to a solid surface (i.e., spray coating, brush coating, dipping, wiping, etc.).

In some embodiments, the coating composition of the present invention may be thixotropic. Thixotropic compositions exhibit time-dependent shear-thinning behaviour. In particular, after exposure to a shear force the viscosity decreases, and time is required for the material to go back to its original state. It can be advantageous for the coating composition disclosed herein to exhibit thixotropic behaviour because it enables the fluid to flow sufficiently to form a uniform layer, then to resist further flow.

In the first aspect, a coating composition with shear-thinning behaviour can be provided through the use of a crosslinked polyhydroxy polymer in a suitable carrier. Polyhydroxy polymers, such as low molecular weight PVA (e.g. less than 30,000 g/mol), may form layers with high crystallinity that can provide a good barrier against hydrogen, but the layers are often highly brittle rendering them unsuitable for use as a hydrogen-barrier coating. In addition, un-crosslinked polyhydroxy polymers dissolved in a carrier have low viscosities at both low shear rates and high shear rates. The low viscosity decreases their usefulness as hydrogen-barrier coating compositions. This is because applying a coating composition with low viscosity to a surface, e.g. the internal surface of a pipe, is very difficult as the liquid simply runs down the pipe walls and pools at the bottom. The coating composition of the first aspect exhibits shear-thinning behaviour. Accordingly, at the time of application, when higher shear rates are applied to the coating composition, the viscosity is lower. Immediately or shortly after application (depending on the extent to which the coating composition is thixotropic), the viscosity of the coating composition will increase such that the coating composition remains in the desired area of application. This may assist in forming a more even coating around e.g. the internal surface of a pipe.

### The Crosslinked Polyhydroxy Polymer

Surprisingly and advantageously, by reacting a polyhydroxy polymer with a hydroxyl-reactive crosslinking agent (crosslinker), a crosslinked polyhydroxy polymer with good hydrogen-barrier properties may be obtained. In the first aspect of the present disclosure, the crosslinked polyhydroxy polymer exhibits advantageous rheological properties, namely shear-thinning behaviour, enabling it to be easily applied to surfaces as a coating.

During the crosslinking reaction, the polyhydroxy polymer is reacted with the hydroxyl-reactive crosslinker (having two or more hydroxyl-reactive groups) that forms covalent or non-covalent links between secondary alcoholic side-chain residues on either different polyhydroxy polymer chains, or different secondary alcoholic side-chain residues on the same polyhydroxy polymer chain.

Without wishing to be bound by theory, it is thought that the crosslinking reaction promotes high viscosity at low shear rates by increasing the molecular weight of the base polymer and linking multiple molecules together. Crosslinked polyhydroxy polymers may be: capable of adopting expanded or open conformations at high shear; and capable of adopting compact or compressed intramolecular conformations at low shear so as to provide shear-thinnable coating compositions. Without wishing to be bound by theory, it is thought that the shear-thinning properties of the coating composition are due to intermolecular interactions and the effects of the hydrogen bond. Intermolecular hydrogen bonds can act to restrict motion and increase viscosity. When exposed to high shear rate force, the interactions may be weakened, resulting in lower viscosity. But without such force, the interaction will gradually form again and the viscosity will return to its original state. Besides the intermolecular interactions, the desired rheology is also associated with the properties of the hydroxyl-reactive crosslinking agent. By crosslinking, the distance between hydroxide groups of polyhydroxy polymer changes due to the crosslinking agent cross-linked in between. For some embodiments, it is believed that the shear-thinning properties of the crosslinked polyhydroxy polymer are promoted due to the hydroxyl-reactive crosslinking agent selected. Specifically, hydroxyl-reactive crosslinking agents with molecules that are flexible may be advantageous as the cross links formed by the hydroxyl-reactive crosslinking agent may more readily uncoil when shear is applied, lowering the viscosity of the crosslinked polyhydroxy polymer.

The amount of crosslinking that occurs between the crosslinker and the polyhydroxy polymer is termed the degree of crosslinking. Specifically, the degree of crosslinking refers to the mol. % of secondary alcoholic side-chain residues in the polyhydroxy polymer that are consumed by the crosslinking reaction. A person skilled in the art would appreciate that the degree of crosslinking of the crosslinked polymer composition is therefore related to the mole ratio between the polymer and crosslinker compounds, as well as the progress and conversion of the crosslinking reaction.

The shear-thinning properties of the crosslinked polyhydroxy polymer can be controlled by controlling crosslinking parameters. For example, decreasing the molar reaction ratio of the polyhydroxy polymer to the hydroxyl-reactive crosslinker can increase the viscosity of the crosslinked polyhydroxy polymer at low shear rates. By increasing the molecular weight of the crosslinker and/or increasing the degree of crosslinking, the viscosity of the final crosslinked polyhydroxy polymer may be increased. The crosslinking reaction time and conditions may be adjusted and selected to provide a desired degree of crosslinking. As another example, increasing the molecular weight of the polyhydroxy polymer can increase the viscosity of the crosslinked polyhydroxy polymer at low shear rates. Crosslinking also affects the crystallinity of the crosslinked polyhydroxy polymer. As discussed above, this in turn is believed to affect the hydrogen permeability thereof. Increasing the molar reaction ratio of the polyhydroxy polymer to the hydroxyl-reactive crosslinker can increase the crystallinity of the crosslinked polyhydroxy polymer. As another example, increasing the degree of crosslinking of the crosslinked polyhydroxy polymer composition can decrease the degree of crystallinity. As yet a further example, increasing the molecular weight of the crosslinker can decrease the crystallinity of the crosslinked polyhydroxy polymer.

Typically, parameters which tend to enhance the shear-thinning properties of the crosslinked polyhydroxy polymer also tend to decrease the crystallinity thereof. Thus, crosslinking reaction conditions are selected that balance these competing factors.

Alternatively or additionally, the rheological properties of the coating composition can be controlled through the addition of a viscosity modifier. A viscosity modifier is a chemical additive that is mixed with the crosslinked polyhydroxy polymer and the carrier for the purpose of increasing or otherwise adjusting the rheological properties of the coating composition. For example, a viscosity modifier may take the form of high (100,000-1,000,000 g/mol) or ultrahigh (>1,000,000 g/mol) molecular weight linear polyhydroxy polymers. In some embodiments, the coating composition will comprise un-crosslinked polyhydroxy polymer. The un-crosslinked polyhydroxy polymer may be the same or substantially similar to the polyhydroxy polymer used to form the crosslinked polyhydroxy polymer. In some embodiments, the un-crosslinked polyhydroxy polymer may comprise unreacted (excess) polyhydroxy polymer that remains after forming the crosslinked polyhydroxy polymer. In some embodiments, un-crosslinked polyhydroxy polymer may be added after the crosslinked polyhydroxy polymer has been formed as part of formulating the coating composition.

### Carrier

The carrier is a solvent for the crosslinked polyhydroxy polymer. Suitable carriers may include water, ethanol or ethanol-water mixtures. Typically, the carrier for the present invention will be water. The hydrogen-barrier coating composition is at least comprised of the crosslinked polyhydroxy polymer in the carrier. After application of the coating composition to a surface, the carrier evaporates, leaving the ultimate coating, i.e. the crosslinked polyhydroxy polymer. The selection of the carrier will influence the time and conditions required for the evaporation thereof after application of the coating composition to a surface. The concentration of crosslinked polyhydroxy polymer can be selected to provide the desired shear-thinning behaviour and/or deposition rate of polymer for a given volume of coating composition.

Components of the crosslinked polyhydroxy polymer derived from the polyhydroxy polymer may constitute up to about 5-20% by weight of the hydrogen-barrier coating composition. In some embodiments, components of the crosslinked polyhydroxy polymer derived from the hydroxyl-reactive crosslinking agent may constitute up to about 20% by weight, such as up to about 5% by weight (e.g. about 1% by weight), of the hydrogen-barrier coating composition. The weight percent of components of the crosslinked polyhydroxy polymer derived from the hydroxyl-reactive crosslinking agent may be more than 20% by weight in some embodiments, for example in some embodiments using a 5:1 molar ratio of the hydroxyl groups in the poly(vinyl alcohol) polymer to the diepoxide crosslinking agent, with the crosslinking agent being 0.5 kDa PEGDGE. The remaining about 60-94% by weight may be the carrier, optionally including components of the crosslinked polyhydroxy polymer derived from a catalyst and/or additives to the composition. The catalyst is described further below.

In embodiments using a catalyst, components of the crosslinked polyhydroxy polymer derived from the polyhydroxy polymer may constitute up to about 5-20% by weight of the hydrogen-barrier coating composition, and components of the crosslinked polyhydroxy polymer derived from the catalyst and the hydroxyl-reactive crosslinking agent may constitute up to about 25% of the hydrogen-barrier coating composition, with the remaining about 55-94% by weight being the carrier. The components of the crosslinked polyhydroxy polymer derived from the catalyst may be up to about 5% by weight. In one embodiment, the coating composition is formed using about 7% by weight polyhydroxy polymer, about 3% by weight catalyst, about 0.9% by weight hydroxyl-reactive crosslinking agent and about 89.1% by weight carrier.

In some embodiments, the crosslinking reaction itself takes places within the carrier. That is, the crosslinked polyhydroxy polymer is formed in situ within the carrier. For example, the polyhydroxy polymer can first be dissolved in the carrier, with the crosslinking agent then added thereto. The resultant solution may then be subjected to conditions (e.g. time, temperature, pressure, etc.) under which the crosslinking reaction is promoted, thereby forming the coating composition.

In some embodiments, the coating composition may be formed shortly before application to the surface. That is, the crosslinked polyhydroxy polymer may be formed in situ within the carrier on site, such as by the end-user of the coating. The coating composition may be prepared at a suitable time before application so that a threshold degree of crosslinking has occurred prior to application in order to provide the desired shear thinning behaviour. In some embodiments, the crosslinking reaction may continue after application as the coating composition dries. A kit for preparing the coating composition may be provided, where the kit may include the distinct polyhydroxy polymer and crosslinking agent components of the coating composition, which are further described below. The polyhydroxy polymer and crosslinking agent may be present in separate containers in the kit, e.g., where the substrate is present in a first container and the crosslinker is present in a second container, where the containers may or may not be present in a combined configuration. The kit may further include a catalyst selected to promote the crosslinking reaction. The catalyst may be provided in an additional, separate, container or combined into the first or second container. One or more of the components of the kit may be pre-blended with the carrier or a portion of the carrier. Alternatively, the carrier will be added to the components of the kit as part of forming the coating composition using the kit.

The skilled person will appreciate that the carrier is thus selected based on the polyhydroxy polymer and crosslinker, i.e. so that both components are soluble in the carrier. For example, if the polyhydroxy polymer and crosslinker are soluble in water, water is selected as the carrier. Alternatively, if the polyhydroxy polymer and crosslinker are soluble in ethanol, then ethanol is selected as the carrier.

In this regard, it is advantageous if the crosslinker selected is soluble in the same carrier as the polyhydroxy polymer that is selected. For example, if the polyhydroxy polymer is soluble in water, then a crosslinker is selected which is likewise soluble in water. Alternatively, if the polyhydroxy polymer is soluble in ethanol, then a crosslinker is selected which is likewise soluble in ethanol.

The viscosity of the coating composition may be affected by the weight concentration of crosslinked polyhydroxy polymer in the carrier. In particular, as the weight concentration of the crosslinked polyhydroxy polymer in the carrier increases, the viscosity of the coating composition likewise increases. The weight concentration of the crosslinked polyhydroxy polymer may be selected such that the coating composition has the desired viscosity.

In other embodiments, the crosslinked polyhydroxy polymer is first formed, for example in a suitable solvent, and then blended with the carrier to form the coating composition. For example, the crosslinked polyhydroxy polymer may be formed in a first solution, and then blended with the carrier. As will be explained below, this may be advantageous when a catalyst is required to promote the crosslinking reaction.

In this embodiment, a carrier is selected in which the crosslinked polyhydroxy polymer is soluble. Again, the viscosity of the coating composition may be affected by the weight concentration of crosslinked polyhydroxy polymer in the carrier. It will be appreciated that, in these embodiments, the amount of crosslinked polyhydroxy polymer blended in the carrier may be adjusted so as to achieve a desired viscosity.

### Polyhydroxy Polymer

A polyhydroxy polymer is a polymer which contains primary, secondary or tertiary alcoholic side-chain monomeric residues emanating out from a polymer backbone. For example, suitable polyhydroxy polymers may include: partially hydrolysed poly(vinyl alcohol); fully hydrolysed poly(vinyl alcohol); and poly(vinyl alcohol) copolymer.

Polyhydroxy polymers may be in the form of a homopolymer or copolymer. Polyhydroxy homopolymers consist essentially of repeating monomeric units, whilst a polyhydroxy copolymer can additionally comprise one or more comonomer derived units.

Polyhydroxy polymers may be either linear or branched. Linear polymers consist of a single backbone with no branches, whilst branched polymers consist of a main chain with one or more substituent side chains or branches.

The form of the polymer (i.e. homopolymer or copolymer) and the degree of branching may all have an impact on the rheology, the crystallinity and/or hydrogen permeability of the resulting coating composition and coating. For example, a higher degree of branching can reduce the crystallinity of the polyhydroxy polymer coating, thereby increasing the hydrogen permeability thereof.

As discussed above, the molecular weight of the polyhydroxy polymer affects both the crystallinity and rheology of the crosslinked polyhydroxy polymer. Typically, a number average molecular weight (Mₙ) of the polyhydroxy polymer is in the range of 30,000-200,000 g/mol in order to maintain good rheology of the coating composition and good crystallinity of the coating. As used herein, the Mₙ of the PVA-based polymers is that which is measured using aqueous Size Exclusion Chromatography with multi-angle light scattering detection.

In one variation of the present disclosure, the polyhydroxy polymer is PVA. PVA may be advantageous for us in the coating composition of the present invention as PVA homopolymers and copolymers are able to form materials with regions of bulk crystallinity. Of further advantage is that PVA is water-soluble, allowing water to be used as the carrier of the coating composition. PVA is also readily available on a commercial scale at affordable prices.

As above, the PVA may be in the form of a homopolymer or copolymer. A person skilled in the art will appreciate that a PVA homopolymer consists essentially of repeating “—CH₂CH(OH)—” monomeric units. That is, the PVA homopolymer contains a hydrocarbon backbone with secondary alcoholic side-chain residues. On the other hand, a PVA copolymer comprises a hydrocarbon backbone with secondary alcoholic side-chain residues in addition to one or more comonomer derived residues. A PVA copolymer may be a block, random, alternate, or graft copolymers. Typically, a PVA copolymer comprises greater than 50 mol. % of PVA-derived side-chain residues.

PVA polymers are usually prepared industrially by the partial or complete hydrolysis of poly(vinyl acetate). In some embodiments, the polyhydroxy polymer is selected from the group consisting of: partially hydrolysed poly(vinyl alcohol); fully hydrolysed poly(vinyl alcohol); and poly(vinyl alcohol) copolymer.

In some embodiments, the hydrogen-barrier coating may comprise partially hydrolysed poly(vinyl alcohol) where the vinyl acetate monomeric residues is less than about 10 mol. % based on the total composition of the PVA. Without wishing to be bound by theory, it is thought that the inclusion of higher concentrations of vinyl acetate monomeric residues may disrupt the crystallinity of the hydrogen-barrier coating, resulting in a more permeable coating. Accordingly, in some embodiments, it is advantageous to use a poly(vinyl alcohol) polymer having >98% hydrolysis.

In other embodiments, the hydrogen-barrier coating may comprise PVA co-polymers where the degree of incorporation of vinyl acetate monomeric residues is less than about 2 mol. % based on the total composition of the PVA copolymer.

In some embodiments, the PVA polymer used in a hydrogen-barrier coating is generally composed of an essentially linear polymer. However, in other embodiments, the PVA copolymer may instead be a branched copolymer. Those skilled will understand that a branched PVA copolymer is comprised of a parent PVA copolymer chain, with regular or irregular shorter polymer side-chains substituting for a constituent of the monomer subunit on the PVA copolymer main chain. Without being bound by theory, it is believed that linear PVA chains can more easily adopt conformations that form regions with high crystallinity. By achieving higher crystallinity, coatings formed using a coating composition comprising PVA cross-linked in accordance with the present disclosure may exhibit a lower hydrogen permeability for a given thickness, compared with coatings formed using a cross-linked branched PVA.

The Mₙ of the PVA polymer may be in the range of 30,000-500,000 g/mol. PVA polymers with Mₙ within this range can exhibit hydrogen permeabilities as low as 0.01 Barrer.

### Crosslinking Agent

A hydroxyl-reactive crosslinking agent (crosslinker) is a molecule comprising two or more functionally identical reactive groups (hydroxyl-reactive groups) capable of forming covalent or non-covalent bonds with secondary hydroxyl groups. Epoxides, aldehydes and silyl ethers are examples of such molecules that may be suitable for use as crosslinkers to produce the coating composition of the present disclosure. In the presence of the crosslinker and under suitable conditions, the polyhydroxy polymer is caused to undergo a crosslinking reaction, thereby producing a crosslinked polyhydroxy polymer. The crosslinker and polyhydroxy polymer are selected such that the crosslinked polyhydroxy polymer is suitable for use as a hydrogen-barrier coating.

In some embodiments, a preferred crosslinker is a diepoxide. Diepoxides comprise two epoxide rings, each of which can readily react with hydroxyl groups. In the present invention, the diepoxide crosslinker may be selected from the following: vinylcyclohexene dioxide, butadiene dioxide, or a diglycidyl ether.

When the diepoxide crosslinker is a diglycidyl ether, the diglicidyl ether may be selected from the group consisting of glycerol diglycidyl ether, 1,4-butanediol diglycidyl ether, ethylene glycol diglycidyl ether, isosorbide diglycidyl ether and poly(ethylene glycol) diglycidyl ether (PEGDGE). These diglycidyl compounds consist of two substituted ethylene oxide functional residues.

Typically, the crosslinker has a total molecular weight of about 170-6000 g/mol. The crosslinker may be about 178 g/mol or about 2000 g/mol. If the crosslinker is too short (i.e. its total molecular weight is too low), the resultant crosslinked polyhydroxy polymer may not have the required shear-thinning rheological properties. It is postulated that, if the crosslinker is too short, the crosslinked polyhydroxy polymer may gel too quickly such that it cannot be easily applied to a surface. For example, polyhydroxy polymers cross-linked with glutaraldehyde (with a molecular weight of 100 g/mol) gel too quickly to be applied as a coating.

In some embodiments, when the polyhydroxy polymer selected is PVA, PEGDGE is advantageously selected as the crosslinker. Both PVA and PEGDGE are soluble in water, allowing water to be selected as the carrier. In some embodiments using the combination of PVA and PEGDGE, the crosslinking reaction is a nucleophilic epoxide ring opening reaction, which proceeds as follows:

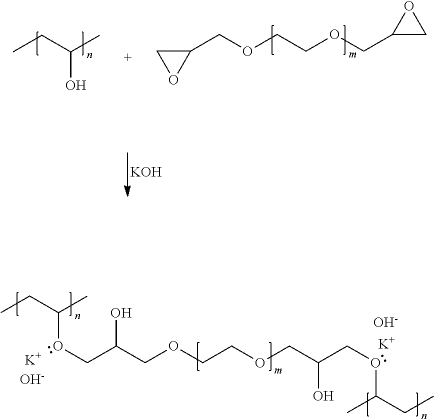

That is, the crosslinking reaction happens between the two epoxide groups at each end of the PEGDGE crosslinker and the hydroxide group in PVA. In the above embodiment, potassium hydroxide is included as a catalyst, the purpose and function of which is described in more detail below.

### Molecular Weight

Without being bound by theory, it is believed that the length/molecular weight of the crosslinker influences the crystallinity and the rheology of the crosslinked polyhydroxy polymer. In particular, increasing the length/molecular weight of the crosslinker tends to decrease the crystallinity of the final crosslinked polyhydroxy polymer. This is because the ability of the crosslinked polyhydroxy polymer to form a crystalline structure via hydrogen bonding is disrupted, due to the presence of the bulkier crosslinker molecules within the chain. The decreased crystallinity may result in an increase in the hydrogen permeability of the crosslinked polyhydroxy polymer. In comparison, a crosslinked polyhydroxy polymer comprising a crosslinker with a lower length/molecular weight may exhibit a greater degree of crystallinity and therefore a lower hydrogen permeability. In this regard, in some embodiments, the molecular weight of the crosslinker may be minimised so that a coating formed using the coating composition has better hydrogen permeability properties.

In general, there is a trade-off between the crystallinity (and hydrogen permeability) of the coating formed using the coating composition of the present invention and the reaction time required to achieve the desired rheology of the coating composition comprising the crosslinked polyhydroxy polymer. Increasing the length/molecular weight of the crosslinker may decrease the reaction time required to achieve a viscosity in the low shear rate region which may enable application of the coating composition to a surface in a more time efficient manner.

Whilst increasing the length/molecular weight of the crosslinker can decrease the crystallinity of the crosslinked polyhydroxy polymer in the coating, it also increases the viscosity of the coating composition at low shear rates. As the lengths of the crosslinking chains increase, the crosslinked polyhydroxy polymer may be able to adopt a greater variety of intramolecular conformations. The increased variety of intramolecular conformations may, in turn, influence the intermolecular interactions within the coating composition and the resulting coating. Furthermore, intramolecular conformational changes and intermolecular interactions within the coating composition may be reversibly manipulated by shear stress, with subsequent changes in viscoelastic properties. Crosslinked polyhydroxy polymers capable of adopting expanded or open conformations at high shear; and capable of adopting compact or compressed intramolecular conformations at low shear may promote shear-thinning behaviour in the coating composition.

Where the components of the coating composition are sold as individual components, it may be advantageous to select a crosslinker of higher molecular weight such that the coating composition achieves the required viscosity in the low shear rate region in a shorter time-frame. When the Mₙ of the polyhydroxy polymer is in the range of about 30,000-200,000 g/mol, the Mₙ of the crosslinker may be in the range of about 170-6000 g/mol. Coatings formed from coating compositions in which the Mₙ of the crosslinker is in this range may exhibit hydrogen permeabilities as low as about 0.01 Barrer.

### Molar Ratio and Degree of Crosslinking

The molar ratio of the polyhydroxy polymer to the crosslinker can influence the properties of the crosslinked polyhydroxy polymer. In particular, as the molar ratio of the polyhydroxy polymer to the crosslinker increases, the crystallinity of the crosslinked polyhydroxy polymer may also increase. This is because there are less crosslinker molecules present within the crosslinked polyhydroxy polymer structure to disrupt the crystallinity thereof. Due to the increase in crystallinity, the hydrogen permeability of the coating may be decreased.

As noted above, typically, there is a trade-off between the hydrogen permeability and rheology of the crosslinked polyhydroxy polymer. This is because the viscosity of the coating composition comprising the crosslinked polyhydroxy polymer in the low shear region decreases as the molar ratio of the polyhydroxy polymer to the crosslinker increases. That is, increasing the molar ratio reduces the shear-thinning behaviour of the crosslinked polyhydroxy polymer.

The degree of crosslinking present in the crosslinked polyhydroxy polymer is correlated to the molar ratio. As the molar ratio of the polyhydroxy polymer to the crosslinker increases, the degree of crosslinking decreases, i.e. there is less crosslinking.

Typically, the ratio of the moles of hydroxyl groups in the polyhydroxy polymer to the moles of crosslinker is between about 50:1 to about 5:1, such as between 30:1 to 5:1. In general, such molar ratios, being the ratio of the moles of hydroxyl groups in the polyhydroxy polymer to the moles of crosslinker, may be selected when the crosslinker comprises two reactive groups. The ratio of the moles of hydroxyl groups in the polyhydroxy polymer to the moles of crosslinker may be adjusted when the crosslinker has more than two reactive groups. The ratio of the moles of hydroxyl groups in the polyhydroxy polymer to the moles of hydroxyl-reactive groups in the crosslinker may be between about 50:2 to about 5:2, such as between 30:2 to 5:2.

If the ratio is too low, there is a marked increase in the hydrogen permeability of the resultant crosslinked polyhydroxy polymer. If the ratio is too high, the crosslinked polyhydroxy polymer may not have the required rheological properties. At a too high molar ratio, the resultant crosslinked polyhydroxy polymer does not exhibit a high enough viscosity in the low shear rate region to be applied to a surface using conventional means.

### Reaction Time

The reaction time of the crosslinking reaction between the crosslinker and the polyhydroxy polymer can influence the rheological properties of the coating composition. In particular, as the reaction time of the crosslinking reaction is increased, the viscosity of the coating composition at low shear rates may increase. This is because, as the reaction time is increase, the degree of crosslinking may also be increased, resulting in shear-thinning behaviour.

### Catalyst

It will be appreciated that the rate at which the crosslinking reaction occurs is dependent on the properties of the polyhydroxy polymer and the crosslinker. For some combinations of polyhydroxy polymer and crosslinker, reaction parameters will be selected to promote the crosslinking reaction. In some embodiments, the rate of such crosslinking reactions can be increased by heating the reaction mixture.

Alternatively or additionally, it can be advantageous to increase the reaction rate in other ways, such as by introducing a catalyst. For example, using a catalyst can facilitate crosslinking shortly before application in underground piping, compared to using heat to increase the reaction rate.

In embodiments where the crosslinking reaction occurs in the carrier, the selected catalyst is added to the carrier, along with the polyhydroxy polymer and crosslinker and is able to catalyse the crosslinking reaction without energy input. In this regard, the selected catalyst is soluble in the selected carrier, i.e. to enable the catalyst to be dissolved within the carrier to thereby catalyse the crosslinking reaction.

Once the coating is applied to a surface and the carrier is evaporated, excess catalyst can optionally be removed from the crosslinked polyhydroxy polymer coating by washing the coating with fresh carrier. When the excess catalyst is removed, a solution comprising the catalyst can be collected and used to regenerate the catalyst. It is noted that removing excess catalyst from the coating does not significantly alter its permeability. Also, removal of the catalyst may not be necessary in all circumstances, for example where the surface being coated already comprises a primer coating.

In embodiments where the crosslinking reaction is performed prior to incorporating the resultant crosslinked polymer into the coating composition, the selected catalyst is added to a suitable solvent, along with polyhydroxy polymer and crosslinker. Typically, the solvent selected will be the same as the carrier. For example, when the carrier selected is water, the solvent selected is also water. The crosslinking reaction is catalysed within the suitable solvent, without the need for energy input. In this regard, the selected catalyst, polyhydroxy polymer and crosslinker are all soluble in the selected carrier, i.e. to enable the crosslinking reaction to occur and to be catalysed.

Once the crosslinking reaction has occurred, the catalyst can be optionally washed from crosslinked polymer using a suitable solvent. For example, the solution comprising the crosslinked polyhydroxy polymer and catalyst can be partially (or completely) dried and then washed with the solvent. The excess catalyst dissolves in the solvent and is thereby removed from the polyhydroxy polymer. The polyhydroxy polymer can then be blended with a carrier to form the coating composition.

Strong alkalis such as hydroxides of alkali metals may increase the reaction rate of the polyhydroxy polymer and the crosslinker. For example, potassium hydroxide and sodium hydroxide can catalyse the crosslinking reaction. Weaker bases, such as ammonium hydroxide or triethyl amine, may still be effective catalysts, although will not increase the reaction rate to the same extent as the strong alkalis.

Alkali metal hydroxides are soluble in water. Therefore, in the present invention, when an alkali metal hydroxide catalyst is employed, water is selected as the carrier. Furthermore, both the selected polyhydroxy polymer and the selected crosslinker are soluble in water.

The use of alkali metal hydroxide catalysts is particularly advantageous because it is less likely to corrode steel compared with acid catalysts. Furthermore, natural gas is usually slightly acidic due to the presence of CO₂ and H₂S. It is postulated that in cases where a mixture of natural gas and hydrogen is present, it can be of further advantage to not wash the coating, in the event the coating becomes wet, because the excess alkali metal hydroxide catalyst may act to neutralise the acidic components of the natural gas.

### Coating Composition

It will be appreciated that the coating composition initially comprises the polyhydroxy polymer, the hydroxyl-reactive crosslinking agent and the catalyst. As above, the polyhydroxy polymer and the hydroxyl-reactive crosslinking agent undergo a crosslinking reaction to form the crosslinked polyhydroxy polymer. It can be possible to control the shear-thinning properties of the coating composition by controlling the concentration of the crosslinked polyhydroxy polymer therein.

In some embodiments, the coating composition may be formed from a precursor composition. The precursor composition comprises the polyhydroxy polymer, the hydroxyl-reactive crosslinking agent and the catalyst. The degree of crosslinking in the precursor composition is such that the precursor composition does not yet have the desired shear-thinning properties and is therefore not yet suitable for use as a coating composition. In this regard, it will be understood that the distinction between the precursor composition and the coating composition is the degree of crosslinking. In particular, the coating composition has the requisite degree of crosslinking such that the composition can display desirable shear-thinning properties and is able to be applied as a coating.

The coating composition can be formed from the precursor composition by allowing crosslinking of the polyhydroxy polymer and the hydroxyl-reactive crosslinking agent to occur within the precursor composition. It will be appreciated that the reaction time required to form the coating composition (i.e. a composition with shear-thinning behaviour) is dependent on multiple factors, as discussed above.

It will be appreciated that the concentration of the crosslinked polyhydroxy polymer may be controlled by adjusting the initial concentration of the polyhydroxy polymer in the coating composition. The amount of hydroxyl-reactive crosslinking agent may then be selected, e.g. based on a selected molar ratio of the polyhydroxy polymer to the crosslinking agent, in accordance with the above description. In some embodiments, the initial concentration of the polyhydroxy polymer is selected based on the selected molecular weight of the polyhydroxy polymer. For instance, when the polyhydroxy polymer has a lower molecular weight, a higher initial concentration may be employed.

Typically, the concentration of the polyhydroxy polymer is such that the coating composition is able to be stirred. This can help ensure the coating composition is homogeneous. In this regard, it is noted that if the concentration of certain polyhydroxy polymers is too high, the resultant coating composition is too viscous and cannot be easily stirred. For example, it is thought that coating compositions comprising more than about 15 wt. % PVA (after crosslinking agent and catalyst addition) may be too viscous to be stirred.

In order for the coating composition to exhibit shear thinning behaviour, at least some amount of crosslinking agent must be added. However, it is thought that the combination of the molecular weight of the polyhydroxy polymer and crosslinking agents, as well as their relative concentrations, will determine the extent of shear thinning.

For example, in some embodiments, coating compositions formed by mixing an aqueous solution comprising at least 15 wt. % PVA with a molecular weight of 89,000-98,000 g/mol with PEGDGE with a molecular weight of 500 g/mol in a 20:1 molar ratio of hydroxyl groups (in the PVA) to PEGDGE can result in the coating composition exhibiting the desired shear-thinning behaviour. It is noted that the initial aqueous solution of PVA can comprise up to about 20 wt. % PVA. Typically, the concentration of the PVA in the solution after addition of the crosslinking agent and catalyst is about 10 wt. % or less, for example about 7 wt. %. In some embodiments, sufficient catalyst may be added so as to enable the crosslinking reaction to proceed at a desired reaction rate. In some embodiments, the catalyst may comprise up to 10 wt. % of the coating composition. Coating compositions formed by mixing an aqueous solution comprising at least 15 wt. % PVA with a molecular weight of 89,000-98,000 g/mol with PEGDGE with a molecular weight of 500 g/mol in a 30:1 molar ratio of hydroxyl groups (in the PVA) to PEGDGE may not result in the coating composition exhibiting the desired shear-thinning behaviour within a desirable reaction time (i.e. the reaction time is longer than preferred). For compositions formed using PVA with a molecular weight of 89,000-98,000 g/mol with PEGDGE with a molecular weight of 500 g/mol, lowering the molar ratio of PVA/PEGDGE can increase the shear-thinning behaviour of the coating composition.

As another example, in some embodiments, coating compositions formed by mixing an aqueous solution comprising at least 10 wt. % PVA with a molecular weight of 146,000-186,000 g/mol with PEGDGE with a molecular weight of 500 g/mol in a 20:1 or 30:1 molar ratio of hydroxyl groups to PEGDGE can result in the coating composition exhibiting the desired shear-thinning behaviour. Typically, the concentration of the PVA in the solution after addition of the crosslinking agent and catalyst is at least about 7 wt. %. It is noted that coating compositions comprising a 20:1 hydroxyl group/PEGDGE molar ratio tend to exhibit better shear-thinning behaviour than coating compositions comprising a 30:1 hydroxyl group/PEGDGE molar ratio.

### Production Method

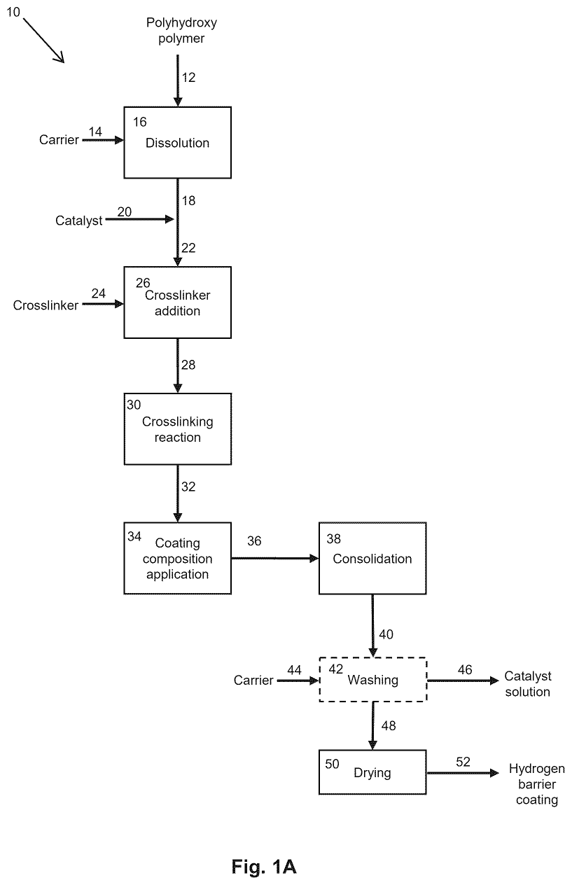

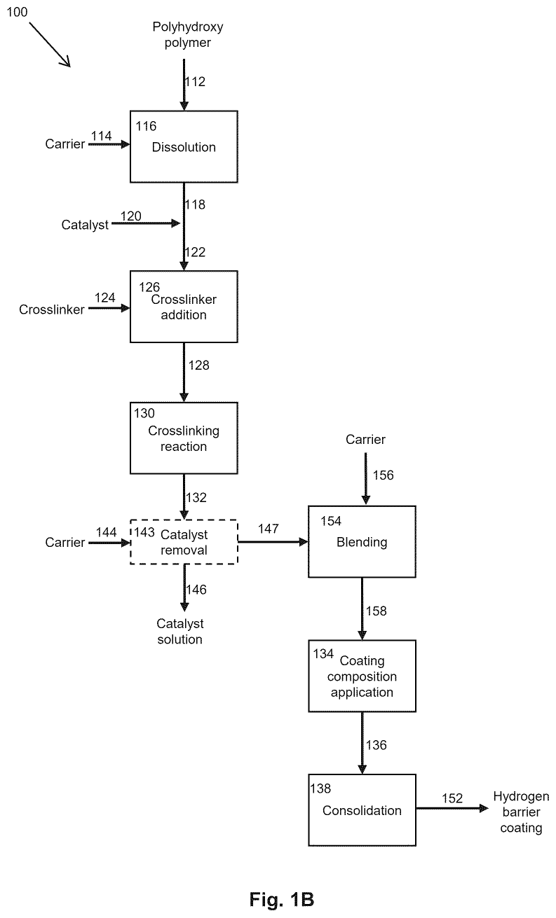

The crosslinked polyhydroxy polymer coating composition of the present invention may be formed by different methods, depending on whether the crosslinking reaction takes place in the carrier (i.e. in situ) or before the coating composition is formulated. The two methods will be described below with reference to FIGS. 1A and 1B. For ease, similar reference numerals are used to denote similar features in each Figure.

The primary difference between the method 10 of FIG. 1A and the method 100 of FIG. 1B is that, in the method 10, excess catalyst is removed after application of the coating composition to a surface, whereas in the method 100, excess catalyst is removed prior to application of the coating composition.

### In Situ Crosslinking

Referring first to FIG. 1A, a block flow diagram of a first method for producing the coating composition of the present invention is provided in which the crosslinking reaction occurs in the carrier directly. In this regard, the crosslinked polyhydroxy polymer coating composition of the present invention may be formed by a method comprising a crosslinking reaction that is conducted sufficiently prior to the application of the composition as a coating such that the coating composition has a viscosity suitable for applying the composition to a surface using conventional means.

In the method 10 of FIG. 1A, the crosslinking reaction is undertaken by reacting a solution of the polyhydroxy polymer with a dissolved crosslinker in the presence of a catalyst.

In a first dissolution stage 16, the polyhydroxy polymer 12 is caused to dissolve in a suitable carrier 14. On a laboratory scale, the dissolution stage 16 can comprise a round bottom flask with a magnetic stirrer. The magnetic stirrer is set to spin at a rate by which the contents of the flask are well-mixed. On a commercial scale, the dissolution stage 16 can analogously comprise a tank comprising an agitator, with continuous movement of the agitator ensuring homogeneity within the tank. Exiting the dissolution stage 16 is the carrier comprising the polyhydroxy polymer in solution 18.

The dissolution stage 16 optionally comprises subjecting the mixture of the polyhydroxy polymer 12 and the carrier 14 to elevated temperatures for a period of time so as to ensure the polyhydroxy polymer 12 is fully dissolved therein. For example, the mixture may be heated to a temperature of about 80-90° C. for about 2 hours. It is noted that the dissolution stage 16 may be performed in advance, for example by the supplier of the polyhydroxy polymer 12. Thus, the input to the process 10 may instead be the solution 18 comprising the carrier and the polyhydroxy polymer dissolved therein.

In the present invention, the carrier is typically water. The solution 18 is generally thus an essentially aqueous solution of the polyhydroxy polymer. The essentially aqueous solution 18 of the polyhydroxy polymer contains about 0.1-50 wt. % polymer content, based on the total weight of the polymer and the carrier contained in the composition.

To increase the rate at which the crosslinking reaction occurs, a catalyst 20, for example a strong alkali metal hydroxide such as potassium hydroxide or sodium hydroxide, is added to the aqueous solution 18 containing the polyhydroxy polymer, prior to the addition of the dissolved crosslinker. As the catalyst 20 is added to the solution 18, the solution 18 becomes alkali, thereby forming an alkali solution 22 comprising the carrier, polyhydroxy polymer and catalyst.

The catalyst 20 can be added to the solution 18 in the same vessel as is used in the dissolution stage 16, i.e. as a batch process in which the polyhydroxy polymer 12 is first dissolved and the catalyst 20 is next added. Alternatively, the catalyst 20 addition can be performed in a separate vessel. As another alternative, for example for large scale processes, the catalyst 20 can be mixed in-line with the solution 18.

The catalyst 20 is generally added in a concentration of up to about 10 wt. %, based on the total weight of the composition. However, it is noted that the catalyst 20 can be added at higher concentrations, as long as the concentration of the catalyst 20 is below its solubility limit in the carrier at the temperature at which the coating composition is to be applied, such as ambient temperature. The catalyst 20 can either be in the form of a solution, e.g. the catalyst 20 may already be dissolved in a separate carrier solution, or in solid form, e.g. as flakes, pellets, prills, etc. As above, the catalyst 20 is typically a strong alkali metal hydroxide, e.g. potassium hydroxide or sodium hydroxide, although weaker bases such as ammonium hydroxide or triethyl amine can also be used.

As the catalyst 20 is added to the carrier, the pH of the aqueous solution 18 containing the polyhydroxy polymer and catalyst can be measured. For example, the quantity of catalyst 20 added may be controlled based on the measured pH, with catalyst added until a desired pH of the alkali solution 22 is reached. Typically, the pH of the alkali solution 20 containing the carrier, the polyhydroxy polymer and the catalyst is within the range of about 10-15, as measured electrochemically immediately after catalyst addition.

Next, the crosslinker 24 is added to the alkali solution 22 in a crosslinker addition stage 26. Typically, the crosslinker 24 is in the form of a solution of the carrier (in this instance water) containing the crosslinker. The molar ratio of the hydroxyl groups in the polyhydroxy polymer to the crosslinker is typically within the range of about 10:1 to about 30:1. In particular, the amount of crosslinker may be selected so as to achieve a certain degree of crosslinking.

On a laboratory scale, the crosslinking addition stage 26 can comprise a round bottom flask with a magnetic stirrer. The magnetic stirrer is operated so as to ensure the contents of the flask are well-mixed. On a larger, e.g. commercial, scale, the crosslinking addition stage 26 can comprise an agitated vessel.

The dissolution stage 16, catalyst addition, and crosslinker addition stage 26 can be performed using the same reaction vessel as sequential (batch) processes. Alternatively, one or more of these stages can be performed in one or more separate reaction vessels. A solution 28 comprising the carrier, the polyhydroxy polymer, crosslinker and catalyst is thereby formed. It will be appreciated that the solution 28 can be classified as a precursor composition for a coating composition for forming a hydrogen-barrier coating. This is because the coating composition is formed from the solution 28 (i.e. precursor composition) by allowing the crosslinking reaction to proceed within the solution 28.

In this regard, the crosslinking reaction 30 is then initiated within the solution 28. This results in the formation of a crosslinked polyhydroxy polymer within the carrier and the formation of the coating composition 32.

The reaction time affects the degree of crosslinking, which in turn affects the rheology of the resultant composition and the permeability of the resultant film. In particular, as the reaction time increases, the amount of crosslinking increases. As will be explained in further detail below with reference to Examples 3 and 4, increasing the reaction time tends to increase the viscosity of the resultant polyhydroxy polymer in the low shear region.

The crosslinking reaction 30 is allowed to proceed until the viscosity of the resultant coating composition 32 comprising the carrier and crosslinked polyhydroxy polymer has a viscosity in the low shear region that enables the composition to be easily applied to a surface, for example by brushing or spraying. Specifically, the crosslinking reaction may proceed until the coating composition 32 exhibits a viscosity of about 10,000 mPa·s to about 100,000 mPa·s under a shear rate of about 0.1 s⁻¹.

Advantageously, the use of the catalyst 20 may enable the crosslinking reaction 30 to be conducted under ambient conditions, for example at room temperature and under standard pressure. In some embodiments, the crosslinking reaction may be accelerated by employing an elevated reaction temperature and/or reaction pressure and/or by light irradiation of the composition during crosslinking.

After the crosslinking reaction 32 has achieved the required degree of completion, or after a certain reaction time has elapsed, the coating composition 32 (comprising the carrier and crosslinked polyhydroxy polymer) is suitable for use as a hydrogen-barrier coating. The coating composition may be applied to a surface to form a protective barrier which acts to reduce the amount of hydrogen that is able to diffuse into the surface material.

In this regard, the method 10 next comprises an application stage 34 in which the coating composition 32 is applied to a surface as a film. For some embodiments, because the coating composition has a viscosity of under 1000 mPa·s under a shear rate of about 5000 s⁻¹, the application stage 34 can comprise conventional coating means such as brushing or spraying. These methods are of particular use when applying the coating composition 32 to a surface in situ, for example when coating the internal walls of an underground pipeline.

However, it will be appreciated that the application stage 34 can comprise other coating means. For example, the coating composition may be applied via solution casting. As another example, the solid surface can be dipped, submerged, or otherwise passed through the coating composition. These methods may be of particular use when applying the coating composition 32 to a surface which is not yet part of existing infrastructure, for example to internally coat newly manufactured pipelines which are yet to be installed.

The applied coating composition 36 still comprises the carrier, i.e. the applied coating composition 36 is ‘wet’. It is noted that, in some embodiments, post application crosslinking can occur. That is, further crosslinking can occur in the ‘wet’ applied coating composition 36. For example, post-application crosslinking can occur because the post application conditions allow for remaining polyhydroxy polymer and crosslinker to continue to react to form crosslinked polyhydroxy polymer. As another example, post-application conditions may be selected so as to cause further crosslinking. This may be advantageous where the required degree of crosslinking has not been achieved in the applied coating composition 36. For embodiments of the coating composition suitable for providing post-application cross-linking, it will be appreciated that cross-linking reactions can also be occurring in the bulk coating composition during the application process. Thus, for embodiments of the coating composition suitable for providing post-application cross-linking the coating composition may have a limited working-life or pot-life during which the degree of cross-linking is such that the rheological characteristics of the coating composition (e.g. the shear thinning behaviour) remains suitable for application. However, beyond the working-life or pot-life of the coating composition, the viscosity of the coating composition may increase such that it cannot be duly applied to the surface to provide the desired coating, for example, the composition may become a non-flowable hydrogel.

Once the coating composition is applied to the surface, the carrier component can be substantially removed therefrom. That is, the coating composition undergoes an in situ consolidation process 38. Typically, the carrier is removed by drying, i.e. evaporation. In some embodiments, as the carrier is removed, the coating composition can form a hydrogel on the surface to which it is applied, before it is completely dry.

Although the crosslinking reaction generally reaches the required degree of completion prior to the consolidation process 38, some further crosslinking can occur during the drying process. In this regard, the consolidation process 38 can comprise a degree of curing. In some embodiments, for example when the required degree of crosslinking has not been achieved in the applied coating composition 36, the consolidation process 38 may be controlled such that the coating composition is also cured.

The consolidation process 38 can comprise allowing the applied coating composition 36 to dry under ambient conditions for a period of between about 10 seconds to 10 days. For example, ambient conditions are often sufficient to consolidate 38 as an applied coating composition 36 in which water and/or ethanol is the carrier 14. This is advantageous because, in certain applications, such as for internally coating underground pipelines, it may be difficult to supply heat, etc. to facilitate the consolidation process 38. However, where it is convenient to do so, the consolidation process 38 of the crosslinked polyhydroxy polymer can be manipulated by means of applying heat. When heat is applied, some curing, i.e. further crosslinking, will also typically occur.

During consolidation, about 80-100% of the carrier is removed from the coating composition. Remaining is a hydrogen-barrier coating 40 comprising the crosslinked polyhydroxy polymer, as well as any carrier that was not evaporated. The coating 40 may form a film of approximately uniform thickness on the surface.

Those skilled will appreciate that the thickness of the film may be controlled in different ways. For example, when the coating composition is applied by spraying, the thickness can be controlled by controlling the air spray pressure and the moving speed of the spray nozzle. As another example, to produce thicker films, multiple layers of the coating composition can be applied to the surface, with each layer allowed to cure (dry) before a successive layer is applied.

It is postulated that, instead of allowing the crosslinking reaction to achieve the desired degree of completion prior to applying the coating, the crosslinking reaction may be completed after its application as a coating to a solid surface. This can be advantageous in situations where there are no vertical or inclined surfaces i.e. a flat horizontal surface.

Referring back to FIG. 1A, the hydrogen-barrier coating 40 remaining after consolidation 38 typically comprises excess catalyst. The excess catalyst may be removed by washing 42 the hydrogen-barrier coating 40 with a fresh solution 44 of the carrier, water in the present invention. As the hydrogen-barrier coating 40 is washed with the carrier 44, excess catalyst is caused to dissolve therein. The excess catalyst and the carrier can be collected as a solution 46. It is noted that the washing stage 42 is optional. In some circumstances, for example where the coating composition is applied to a primer coating, removal of the excess catalyst may not be required. As another example, where the coating composition is applied to the internal surface of a pipe in which natural gas will be transported, it can be advantageous to retain excess catalyst, due to its alkali properties.

In some embodiments of the present invention, the carrier is water, and the catalyst is an alkali metal hydroxide, with the coating 40 washed with water. The alkali metal hydroxide dissolves in the water forming a weakly alkali solution. This solution 46 can be collected and used to regenerate a concentrated alkali metal hydroxide solution for reuse in the production of the coating composition.

Alternatively, the catalyst may be removed from the coating composition following completion of the crosslinking reaction, but prior to its application as a coating to a surface. For example, the alkali metal hydroxide can be recovered through dialysis against water or acid can be added to neutralise the pH.

When the excess catalyst is removed by washing 42, as in the method 10, the hydrogen-barrier coating 40 becomes wet, i.e. because the coating will absorb some of the wash water. As a result, the wet hydrogen-barrier coating 48 undergoes a drying stage 50, in which the hydrogen-barrier coating is left to dry, typically by evaporation under ambient conditions. Again, the use of water and/or ethanol as a carrier is advantageous because the hydrogen-barrier coating can be dried under ambient conditions, without the need to apply heat. Of course, as will be appreciated, heat can be applied to increase the rate at which the hydrogen-barrier coating is dried, if it is convenient to do so.

It will be appreciated that the exact curing/drying time will depend on local conditions, e.g. temperature, humidity etc.

Once drying 50 is completed, a hydrogen-barrier coating 52 remains on the surface. Typically, the thickness of the consolidated, dried hydrogen-barrier coating 52 may be within the range of around 30 μm to around 2000 μm. It is noted that, if the dried hydrogen-barrier coating 52 is too thin, defects can occur increasing its permeability. As above, the thickness of the hydrogen-barrier coating 52 affects the amount of hydrogen that can penetrate into the surface onto which it is coated.

It will be appreciated that the dry thickness of the film can be made thinner than 30 μm or thicker than 2000 μm, depending on the application. For example, where the surface is less prone to hydrogen embrittlement such that it can comprise a higher concentration of hydrogen, or the coating composition has a relatively low permeability, a thin film of the coating may be sufficient. However, when the coating has a higher permeability per unit thickness and/or where it is necessary to further reduce the amount of hydrogen that is able to contact the surface, a thicker film of the coating may be required. A thicker film may provide better protection against hydrogen embrittlement as more time is required for hydrogen to diffuse through the film and reach the surface compared to a thinner film with the same hydrogen permeability.

The final hydrogen-barrier coating 52 can have a permeability of less than 0.04 Barrer, such as below about 0.01 Barrer. As described above, the permeability of the hydrogen-barrier coating may be increased or decreased by adjusting different parameters within the method 10 such as the molecular weight of the polyhydroxy polymer and/or crosslinker, the molar ratio of the polyhydroxy polymer to the crosslinker, the amount of crosslinking, etc. Advantageously, the final hydrogen-barrier coating 52 can act as a hydrogen-barrier even under ambient conditions.

### Crosslinking Prior to Blending

Referring now to FIG. 1B, a block flow diagram of a second method for producing the coating composition of the present invention is provided in which the crosslinked polyhydroxy polymer is first formed and then blended with the carrier to form the coating composition.

An example of such a method 100 is depicted in FIG. 1B in block diagram form. In the method 100, the crosslinking reaction is effectively undertaken by reacting a solution of the polyhydroxy polymer with a dissolved crosslinker in the presence of a catalyst.

The initial stages of the method 100 from the dissolution stage 116 to the crosslinker addition 126 are essentially the same as the initial stages of the method 10, so will not be described again in detail. The primary difference is that, in the method 100, the solvent used in the dissolution stage 116 need not be the carrier ultimately used to form the coating composition.

As in the method 10, in the method 100, the crosslinking reaction 130 is initiated within the solution 128 comprising the carrier, the polyhydroxy polymer, crosslinker and catalyst. This results in the formation of a crosslinked polyhydroxy polymer within the carrier. As above, the reaction time affects the degree of crosslinking, which in turn affects the rheology of the resultant composition and the permeability of the resultant film. The crosslinking reaction 130 is allowed to proceed until a desired degree of crosslinking has been achieved, typically around 80%.

As above, the use of the catalyst 120 may enable the crosslinking reaction 130 to be conducted under ambient conditions. However, the crosslinking reaction may be accelerated by employing an elevated reaction temperature and/or reaction pressure and/or by light irradiation of the composition during crosslinking.

As the crosslinking reaction 130 progresses, a solution 132 comprising the carrier and crosslinked polyhydroxy polymer is formed. The solution 132 typically further comprises catalyst.

After the crosslinking reaction 130 has achieved the required degree of completion, or after a certain reaction time has elapsed, the carrier comprising the crosslinked polyhydroxy polymer may be subjected to a catalyst removal stage 143. In the catalyst removal stage 143, the excess catalyst may be removed from the solution 132. As above, the catalyst removal stage 143 is optional. For example, where it is advantageous to have excess catalyst present on the coating, the catalyst removal stage 143 may be omitted.

Typically, the catalyst removal stage 143 (when present) employs a two-stage process. In a first drying stage, excess carrier is removed from the solution 132, for example by evaporation, thereby forming a dry or partially dry crosslinked polyhydroxy polymer. In a second wash stage, the dry or partially dry crosslinked polyhydroxy polymer is washed with a fresh solution of the carrier 144, i.e. water in the present invention. As the dry or partially dry crosslinked polyhydroxy polymer is washed with the carrier 144, excess catalyst is caused to dissolve therein. The excess catalyst and the carrier can be collected as a solution 146.

It is noted that alternatively, the catalyst removal stage 143 can instead comprise a separation stage, i.e. instead of a drying stage and a washing stage. In the separation stage, excess catalyst can be separated from the crosslinked polymer and unreacted PVA/PEGDGE, for example using a membrane. A separation stage may be employed where further crosslinking of the PVA and PEGDGE is desired after washing. Leaving the catalyst removal stage 143 is a concentrated solution comprising crosslinked polymer and unreacted PVA/PEGDGE. Excess catalyst is likewise collected as a solution 146.

The crosslinked polyhydroxy polymer, now wet (or still wet) because of the catalyst removal stage 143 is then blended 154 with more carrier 156 to form the coating composition. In particular, in some embodiments, carrier 156 is blended 154 with the crosslinked polyhydroxy polymer 147 until the resultant coating composition 158 has a viscosity of about 10,000 mPa·s to about 100,000 mPa·s under a shear rate of about 0.1 s⁻¹.

As above, in the subsequent application stage 134, the coating composition 158 is applied to a surface as a film. Because of the shear-thinning behaviour of the coating composition 158, the application stage 134 can comprise means such as brushing or spraying. These methods are of particular use when applying the coating composition 158 to a surface in situ, for example when coating the internal walls of a pipeline or storage vessel.

However, as above, the application stage 134 can comprise other coating means. For example, the coating composition may be applied via solution casting. As another example, the solid surface can be dipped, submerged, or otherwise passed through the coating composition.

The applied coating composition 136 is ‘wet’, i.e. because it comprises both the crosslinked polyhydroxy polymer and the carrier into which it was blended. Once the coating composition is applied to the surface, the carrier component is substantially removed therefrom. That is, the coating composition undergoes an in situ consolidation process 138. Typically, the carrier is removed by drying, i.e. evaporation. Unlike the method 10, because there is minimal catalyst in the coating composition 136, no further crosslinking occurs.

As above, the consolidation process 138 can comprise allowing the applied coating composition 136 to dry under ambient conditions for a period of between about 10 seconds to 10 days. For example, ambient conditions are often sufficient to consolidate 138 an applied coating composition 136 in which water and/or ethanol is the carrier. This is advantageous because, in certain applications, such as for internally coating underground pipelines, it may be difficult to supply heat, etc. to facilitate the consolidation process 138. However, where it is convenient to do so, the consolidation process 138 of the crosslinked polyhydroxy polymer can be manipulated by means of applying heat.

As above, during consolidation, about 80-100% of the carrier is removed from the coating composition. Remaining is a hydrogen-barrier coating 152 comprising the crosslinked polyhydroxy polymer, as well as any carrier that was not evaporated. The coating may have an approximately uniform thickness on the surface of around 30 μm to around 2000 μm, such as around 300 μm.

As above, the thickness of the coating may be controlled in different ways, including during application thereof.

As above, the thickness of the coating can be adjusted, depending on the application.

As above, the final coating 152 can have a permeability of less than about 0.04 Barrer, such as below about 0.01 Barrer. The permeability of the hydrogen-barrier coating may be increased or decreased by adjusting different parameters within the method 100 such as the molecular weight of the polyhydroxy polymer and/or crosslinker, the molar ratio of the polyhydroxy polymer to the crosslinker, the amount of crosslinking, etc. As above, the final coating 52 can act as a hydrogen-barrier even under ambient conditions.

### Use as a Coating

The hydrogen-barrier coating comprising the crosslinked polyhydroxy polymer may be suitable for use in a wide-range of applications. The coating composition may be suitable for application to a wide-range of surfaces. Of particular advantage is that the coating composition is suitable for use in coating the internal walls of pipelines and storage vessels within existing natural gas infrastructure. As society looks to transition from natural gas to more renewable sources of energy, such as hydrogen, it is advantageous if hydrogen (or blends of natural gas and hydrogen) can be transported using the existing infrastructure.

The coating composition may be suitable for application on steel surfaces to provide a hydrogen-barrier coating on the steel. When steel is exposed to hydrogen, hydrogen diffuses into the steel over time and the steel becomes embrittled. This can lead to degradation of the mechanical properties of the steel pipes, for example, ductility, fracture toughness and fatigue. The hydrogen-barrier coating of the present disclosure may have a permeability of less than 0.04 Barrer, such as below about 0.01 Barrer. As described above, the thickness of the applied hydrogen-barrier coating can be increased to provide the desired protection against hydrogen exposure for the particular application.

The coating composition can be applied to new, bespoke piping systems and storage vessels designed specifically for hydrogen transportation and storage.

The coating composition may be suitable for use on a wide-range of metallic surfaces, i.e. other than steel pipes. For example, the coating composition may be used to coat tanks, sumps, barrels, valves or other metallic surfaces in contact with a gas comprising hydrogen in which it is advantageous to reduce the amount of hydrogen that is able to diffuse into the metallic surface.

Over time, as hydrogen permeates into the hydrogen-barrier coating, the coating itself becomes saturated in hydrogen. As a result, hydrogen is able to more easily diffuse into the coated surface. Thus, the coating will have a working life during which it can provide an effective hydrogen-barrier, but the efficacy of the coating decreases over time.

### EXAMPLES

Non-limiting examples will now be described, to further illustrate exemplary embodiments of the present invention.

### Example 1—Methodology

In this Example, the methodologies used to prepare and test different the crosslinked polyhydroxy polymers of the remaining examples is described. Poly vinyl alcohol (PVA, 89,000-98,000 g/mol, 99+% hydrolyzed) from Sigma (St. Louis, USA), epoxy poly (ethylene glycol) diglycidyl ether (PEGDGE) from Merck Pty Ltd and potassium hydroxide (KOH) from UNIVAR were used. Gas cylinders of H₂ (99.99% purity) was supplied by Core gas Pty Ltd.

A PVA aqueous solution with a concentration of 10-15 wt. % was prepared by adding the PVA powder into deionized water in a round bottom flask fitted with a magnetic stirrer. The speed of the magnetic stirrer was increased until it was observed that the contents of the flask were being mixed effectively.

The flask was placed in a water bath at 80-90° C. and the mixture was stirred for 2 h under reflux until the PVA was completely dissolved and a homogeneous solution was obtained. The solution was transferred into a glass bottle and left overnight to eliminate gas bubbles formed during stirring.

KOH was dissolved in water and then added into the PVA solution under magnetic stirring. Once the KOH was observed to be dissolved, the PEGDGE liquid was added into the mixture drop-wisely under stirring. The final PVA concentration was calculated to be 10 wt. %.

Different KOH concentrations and different molar reaction ratios were explored and summarised in Table 1. Samples are named based on their molar ratio of hydroxyl groups (in the PVA) to PEGDGE and KOH concentration during reaction. For example, the sample named “20-1-3” means the molar ratio of hydroxyl groups in the PVA to the PEDGE crosslinker was 20/1 and KOH concentration was 3 wt. % in the reaction.

TABLE 1
Molar ratios of hydroxyl groups to PEGDGE and
KOH concentrations for different samples.

| | Molar ratio of hydroxyl | KOH concentration |
|---|---|---|
| Sample Name | groups to PEGDGE | (wt %) |
| 10-1-10 | 10/1 | 10 |
| 20-1-3 | 20/1 | 3 |
| 20-1-10 | 20/1 | 10 |
| 30-1-3 | 30/1 | 3 |
| 30-1-10 | 30/1 | 10 |

Films were prepared from the reaction mixture using a solvent casting method. The reaction solution was casted onto a cellophane sheet with an acrylic frame and left under ambient conditions to dry for 7 to 10 days. When the film was touch-dry, it was rinsed with deionized water several times to remove the excess KOH. Then, the film was left to dry in ambient conditions again for 3 to 5 days. When completely dry, the film was stored in a vacuum desiccator before characterization measurements. The film thickness was measured by a micrometer (Mitutoyo, Japan) with an accuracy of ±1 μm. The thickness of fabricated films was around 200-300 μm.

The overall reaction can be illustrated as follows:

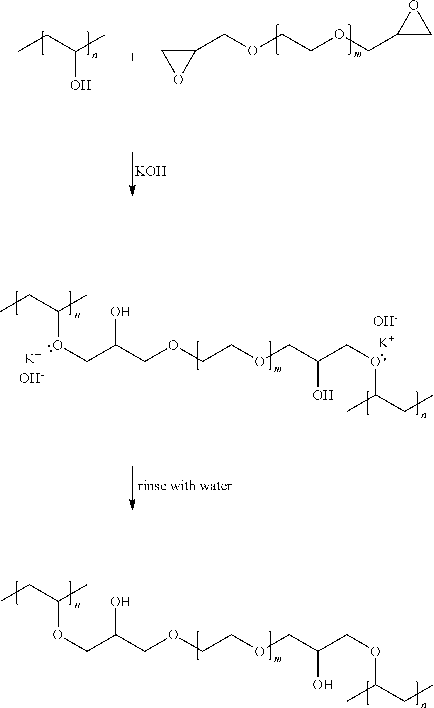

### Single Gas Permeation Measurement

The single gas permeability of the free-standing films for different gases was tested using a constant volume/variable pressure apparatus at 35±0.1° C. The permeate side was under vacuum and the feed side was supplied with hydrogen gas at 9 bar. The downstream pressure was recorded with time to calculate the gas permeability.

### Rheology Measurement

The rheological properties of the coatings were measured for different reaction ratios and reaction time using a MCR702 TwinDrive Rheometer (Anton Paar) at 25° C. The reaction time for the PVA/PEGDGE samples was taken as the time after the PEGDGE was added into the mixture. A cone-and-plate geometry was adopted with a diameter of 25 mm and a gap of 0.102 mm. Frequency sweep testes were carried out in an oscillatory mode over the range from 0.01 to 8900 rad/s. The change of viscosity and shear stress as a function of shear rate were obtained.

### X-Ray Diffraction

X-ray diffraction (XRD) was carried out to determine the crystallinity of samples, utilizing a D8 Advance Diffractometer (Bruker, Germany) with a Ni-filtered CuKα radiation source at 30 mA and 40 kV, scanning over a 2θ range from 10° to 60° at a rate of 0.02° every second.

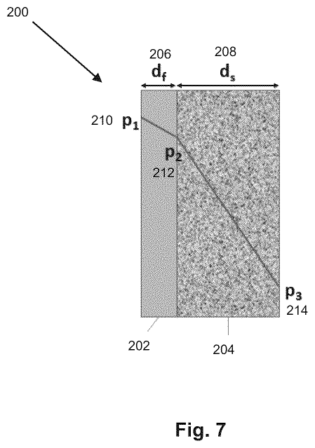

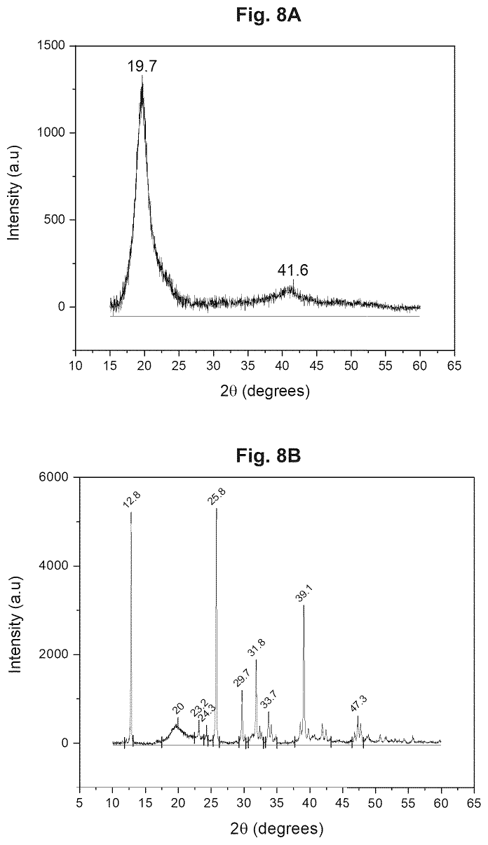

The XRD diffractogram in FIG. 8A is for a film comprised of PVA only, formed from the PVA obtained from Sigma (i.e. with an Mₙ of 89,000-98,000 g/mol and 99+% hydrolyzed). The XRD shows two peaks at 2θ of 19.7° and 2θ of 41.6°. These peaks are characteristic of PVA, resulting from its semi-crystalline structure. To determine the fraction of crystallinity, it was assumed that the semi-crystalline polymer had two phases—a crystalline region and an amorphous region. The amorphous phase did not have any characteristic peaks associated with it, i.e. because it was amorphous.

The XRD diffractogram in FIG. 8B is for a film comprised of a crosslinked PVA/PEGDGE polymer, formed using the above-described methodology. A molar ratio of PVA to PEGDGE of 30:1 was used and the KOH concentration was 3 wt. %. It was noted that the XRD of FIG. 8B comprised many peaks, which were related to the presence of the crosslinked polymer and the catalyst. The peaks corresponding to PVA were still present because there was excess (i.e. unreacted) PVA present.

The crystallinity was calculated from the ratio of the integrated area of all crystalline peaks to the total integrated area under the XRD peaks. Using this methodology, in the case of FIG. 8A, the crystallinity was calculated to be 83.3%. In the case of FIG. 8B, the crystallinity was calculated to be 76.3%.

### Example 2—Effect of PVA/PEGDGE Ratio and KOH Concentration on H₂ Permeability

In a first set of experiments, the effect of the molar ratio of hydroxyl groups to PEGDGE and the concentration of KOH catalyst in the carrier on the hydrogen permeability and crystallinity of the resultant crosslinked polyhydroxy polymer was tested. The methodology afore-described in Example 1 was used. Table 2 summarises the hydrogen permeability results and crystallinity of tested films. Pure PVA is included for reference.

TABLE 2
Hydrogen permeability and crystallinity for crosslinked
PVA/PEGDGE polymers as a function of the PVA hydroxyl
groups/PEGDGE molar ratio and KOH concentration.

| Molar ratio of | | | |
|---|---|---|---|
| PVA hydroxyl | KOH | H₂ | |
| groups to | concentration | permeability | Crystallinity |
| PEGDGE | (wt %) | (Barrer) | (%) |
| 10/1 | 10 | 0.32 ± 0.002 | 54.6 |
| 20/1 | 3 | 0.057 ± 0.001 | 68.8 |
| 20/1 | 10 | 0.059 ± 0.004 | 69.3 |
| 30/1 | 3 | 0.036 ± 0.001 | 76.3 |
| 30/1 | 10 | 0.035 ± 0.001 | 75.0 |
| Pure PVA | — | 0.015 ± 0.001 | 83.3 |

Samples with a molar ratio of hydroxyl groups to PEGDGE of 20/1 and 30/1 had a hydrogen permeability around 0.058 and 0.036 Barrer respectively. It was noted that this was an order of magnitude lower than the hydrogen permeability of two commercial epoxy coatings which were also tested. This showed the potential for using PVA/PEGDGE crosslinked polymers as coating materials to impede hydrogen permeation.

For the same hydroxyl groups/PEGDGE molar ratio, films made from carriers comprising KOH concentrations of 3 wt. % and 10 wt. % had similar hydrogen permeability. Hence, the concentration of KOH did not significantly influence hydrogen permeability of films.

It was noted that, in the reaction, the hydroxyl groups in PVA act as nucleophiles, attacking the C2 atom of terminal epoxide moieties in PEGDGE, which results in the crosslinked structure. During the crosslinking reaction, KOH provides a nucleophilic hydroxide ion, creating alkaline condition for the base-catalysed epoxide ring opening reaction.

Pure PVA had the lowest hydrogen permeability (0.015 Barrer) among all tested films. The hydrogen permeability of crosslinked polymer films decreased as the reaction ratio of PVA was increased. Specifically, crosslinked films with the highest hydroxyl group/PEGDGE monomer molar ratio of 30/1 had the lowest hydrogen permeability of 0.035 Barrer, whilst the hydrogen permeability of films with a ratio of 10/1 was ten-fold higher at 0.32 Barrer.

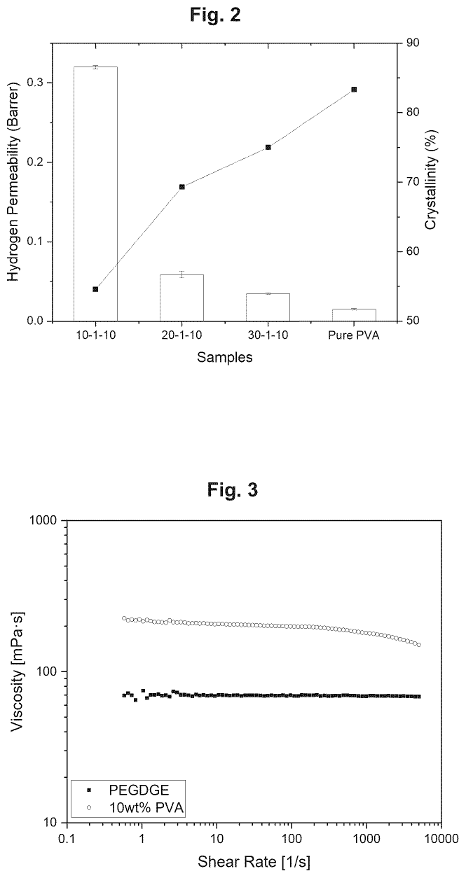

The hydrogen permeability and crystallinity as a function of the molar ratio of hydroxyl groups to PEGDGE is shown in FIG. 2. From FIG. 2, it can be seen that the hydrogen permeability of the films was influenced by the degree of crystallinity. Specifically, films with a higher degree of crystallinity had lower hydrogen permeability. Pure PVA film had the highest degree of crystallinity of 83.3%, resulting from the semi-crystalline nature of PVA. This is because the hydroxyl groups within PVA chains can form folded and compacted crystalline regions due to the inter-molecular and intra-molecular hydrogen bonding that occurs. The crystalline regions are largely impermeable, thus increasing the diffusion path of hydrogen gas molecules and reducing hydrogen permeability.

As the stoichiometric monomer molar ratio of hydroxyl groups to PEGDGE was decreased from 30/1 to 10/1, it was hypothesised that there was more crosslinking between hydroxide groups of PVA and epoxide groups of PEGDGE. This was because the stoichiometric reaction molar ratio of hydroxyl groups of PVA to PEGDGE was 2/1. As a result, the degree of crystallinity in the crosslinked polymer film decreased, which in turn increased the hydrogen permeability. Thus, the crosslinking reaction was observed to decrease the degree of crystallinity.

### Example 3—Effect of PVA Molecular Weight on H₂ Permeability

In a second set of experiments, the effect of the molar ratio of hydroxyl groups to PEGDGE and the molecular weight of PVA on the permeability of the resultant crosslinked polyhydroxy polymer was tested. The methodology afore-described in Example 1 was used, except that for the second two polymer coatings, PVA with a molecular weight of 146,000-186,000 g/mol was used. The KOH concentration was kept constant at 3 wt. %. Table 3 summarises the hydrogen permeability results.

TABLE 3
Hydrogen permeability for crosslinked PVA/PEGDGE polymers
as a function of the molar ratio of PVA hydroxyl groups
to PEGDGE, at a constant KOH concentration of 3 wt. %.

| | Molar ratio of | |
|---|---|---|
| | hydroxyl groups to | H₂ Perm. |
| PVA Mₙ (g/mol) | PEGDGE | (Barrer) |
| 89,000-98,000 | 20:1 | 0.057 ± 0.001 |
| | 30:1 | 0.036 ± 0.001 |
| 146,000-186,000 | 20:1 | 0.040 ± 0.001 |
| | 30:1 | 0.011 ± 0.001 |

For the same PVA molecular weight, samples with a molar ratio of hydroxyl groups to PEGDGE of 30:1 had a lower hydrogen permeability compared to samples with a molar ratio of 20:1. As in Example 2, the lower hydrogen permeability of samples with higher amounts of hydroxyl groups compared with PEGDGE was attributed to the increase in crystallinity for samples with a hydroxyl group/PEGDGE molar ratio of 30:1.

For the same hydroxyl group/PEGDGE ratio, samples formed using PVA with a molecular weight of 146,000-186,000 g/mol had lower hydrogen permeabilities compared with samples formed using PVA with a molecular weight of 89,000-98,000 g/mol. In particular, by using PVA with a molecular weight of 146,000-186,000 g/mol at a 30:1 ratio of hydroxyl groups to PEGDGE, a film with a hydrogen permeability of 0.011 Barrer was formed.

### Example 4—Effect of PVA/PEGDGE Ratio on Composition Rheology

In another set of experiments, the effect of the molar ratio of hydroxyl groups to PEGDGE on the rheology of the resultant composition was studied. Rheology measurement results are presented in FIGS. 3, 4 and 5.

First, the rheology of a PVA aqueous solution with a concentration of 10 wt. % and a solution of PEGDGE were measured. These results are shown in FIG. 3. PEGDGE was observed to be a Newtonian liquid, as its viscosity did not change as a function of shear rate. The PVA aqueous solution showed a very slight shear-thinning behaviour, with a viscosity of about 250 mPa·s at a shear rate of about 0.5 s⁻¹ and a viscosity of about 100 mPa·s at a shear rate of about 10,000 s⁻¹.

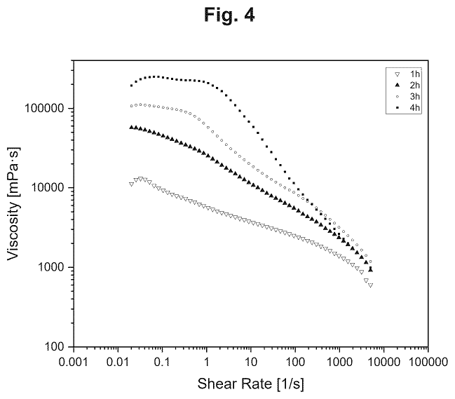

Next, the rheology of compositions comprising the crosslinked PVA/PEGDGE were measured. These rheology measurements for the 20-1-10 sample are shown in FIG. 4. The time relates to the time that elapsed between when the PEGDGE was added to the PVA solution (comprising KOH) and when the rheology of the solution was measured. That is, it is effectively a reaction time.

Surprisingly and advantageously, after the crosslinking reaction, the coating composition exhibited shear-thinning behaviour. In the high shear region of 10,000 s⁻¹, all samples showed the same viscosity of about 1,000 mPa·s. All samples also showed a viscosity of above 10,000 mPa·s in the low shear region of 0.01 s⁻¹. However, the viscosity in the low shear region was affected by the reaction time, with the viscosity increasing with increasing reaction time. It was noted that this was likely due to the degree of crosslinking, with longer reaction times allowing for more crosslinking to occur.

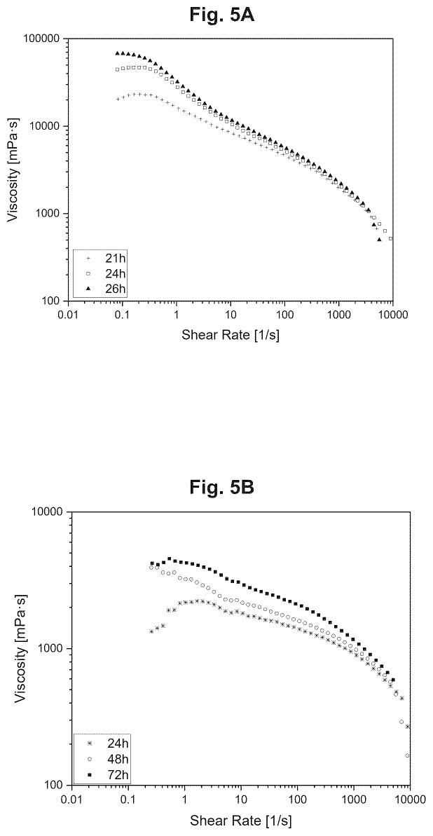

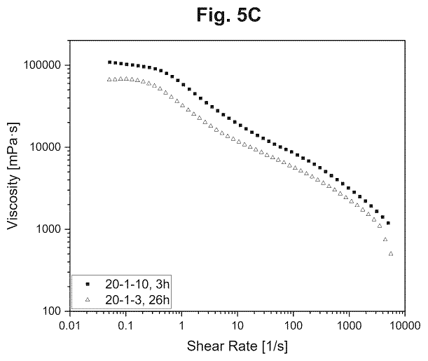

FIG. 5A shows the results of rheology measurements for the 20-1-3 sample for different reaction times and FIG. 5B shows the results of rheology measurements for the 30-1-3 sample for different reaction times. Again, in the high shear region of 10,000 s⁻¹, all samples showed similar viscosities of about 800 mPa·s for the 20-1-3 composition and about 200 mPa·s for the 30-1-3 composition. The viscosity in the low shear region of 0.1 s¹ was again a function of reaction time, with the viscosity increasing as the reaction time increased.

Specifically, for the 20-1-3 sample in FIG. 5A, after reaction for 21 hours, the viscosity reached around 20,000 mPa·s at a low shear rate (between 0.05 to 0.5 s⁻¹) and decreased to below 1,000 mPa·s at high shear rate between 5,000 to 10,000 s⁻¹. The viscosity in the low shear rate region increased to 67,000 mPa·s as the reaction time increased to 26 h, whilst the viscosity in the high shear rate region remained below 1,000 mPa·s.

The concentration of KOH did not influence the film hydrogen permeability, but did impact the reaction time. FIG. 5C compares the rheological properties of the 20-1-10 sample after 3 h and the 20-1-3 sample after 26 h. It was observed that, even after 26 h, the 20-1-3 sample still had a lower viscosity in the low shear region. Specifically, the 20-1-3 sample had a viscosity of about 70,000 mPa·s at a shear rate of 0.1 s⁻¹, whilst the 20-1-10 sample had a viscosity of over 100,000 mPa·s for the same shear rate. The 20-1-10 sample achieved this viscosity in only about 3 h. It was noted that this was likely due to the rate at which crosslinking occurred, with higher crosslinking reaction rates in the sample with a higher KOH concentration.

Referring now to FIG. 5B, sample 30-1-3 was observed to exhibit shear-thinning rheology, but its viscosity was lower than the other samples. In the low shear rate region, the viscosity only increased to around 4,500 mPa·s even after a reaction time of 72 hours. It was noted that this viscosity was not viscous enough for a coating material. At higher hydroxyl group/PEGDGE molar ratios, such as at a ratio of 30:1, the concentration of PEGDGE and percentage of crosslinked material is decreased, resulting in less enhancement in viscosity and shear-thinning property.

### Example 5—Effect of PVA/PEGDGE Ratio on Thixotropic Behaviour

In another set of experiments, the effect of the molar ratio of hydroxyl groups to PEGDGE and the molecular weight of PVA on the thixotropic properties of the crosslinked polyhydroxy polymer was tested. The methodology afore-described in Example 1 was used, except that PVA with a molecular weight of 146,000-186,000 g/mol was used.

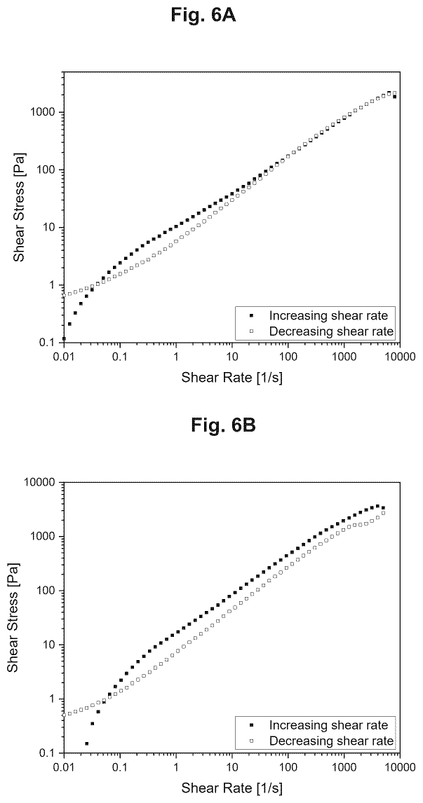

FIG. 6A shows the shear stress as a function of shear rate for sample 30-1-3 after 72 h reaction time and FIG. 6B shows the shear stress as a function of shear rate for sample 20-1-3 after 21 h reaction time. The hysteresis curves for both crosslinked polymer coating compositions indicated they were thixotropic.

### Example 6—Effect of PVA Molecular Weight on Composition Rheology

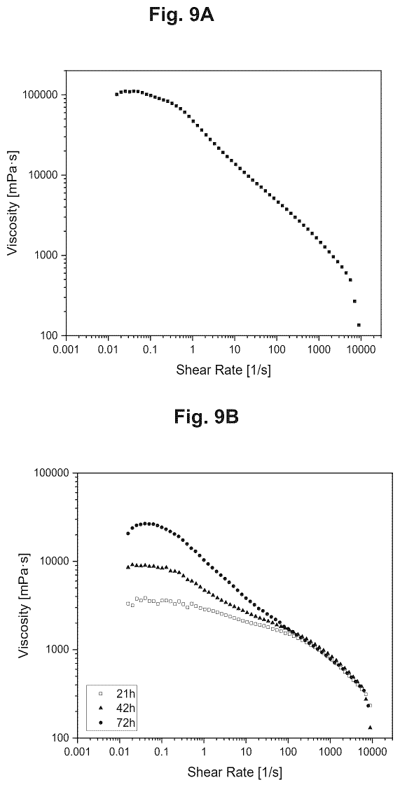

In another set of experiments, the effect of the molecular weight of PVA on the rheology of the resultant composition was studied. The methodology afore-described in Example 1 was used, except that PVA with a molecular weight of 146,000-186,000 g/mol was used and the final concentration was 7 wt. % PVA. Rheology measurement results are presented in FIGS. 9A and 9B. FIG. 9A shows the rheology of the 20-1-3 sample after 21 h and FIG. 9B shows the rheology of the 30-1-3 sample at different reaction times.

Both samples exhibited shear-thinning behaviour, with a viscosity of over 1,000 mPa·s at a shear rate of 0.01 s⁻¹ and a viscosity of around 100 mPa·s at a shear rate of 10,000 s⁻¹.

The 20-1-3 sample had a higher viscosity in the low shear region than any of the 30-1-3 samples, with a viscosity of approximately 100,000 mPa·s at a shear rate of 0.01 s⁻¹. On the other hand, the viscosity of the 30-1-3 sample was approximately 20,000 mPa·s after 72 h of reaction. It was noted that the viscosity of the 30-1-3 sample may be further increased by increasing the reaction time. However, the viscosity of 20,000 mPa·s was sufficient to allow the composition to be applied as a coating.

It was further noted that this was consistent with the trend observed for molar ratio when the molecular weight of PVA was 89,000-98,000 g/mol. Similarly, as FIG. 9B shows, the viscosity in the low shear region increased as a function of reaction time.

It was observed that the viscosity of the samples with PVA molecular weights of 146,000-186,000 g/mol exhibited higher viscosities in the low shear region, compared with samples made from 89,000-98,000 g/mol PVA. For example, the 20-1-3 sample with 146,000-186,000 g/mol PVA had a viscosity of about 100,000 mPa·s at a shear rate of 0.01 s⁻¹ after 21 h reaction time, whilst the 20-1-3 sample with 89,000-98,000 g/mol PVA only had a viscosity of about 20,000 mPa·s at the same shear rate and after the same reaction time.

Similarly, for the 30-1-3 sample with 146,000-186,000 g/mol PVA, a viscosity of over 10,000 mPa·s at a shear rate of 0.01 s⁻¹ was obtained after 72 h. On the contrary, for the 30-1-3 sample with 89,000-98,000 g/mol PVA, the viscosity remained below 10,000 mPa·s at a shear rate of 0.01 s⁻¹, even after 72 h.

### Example 7—Effect of PEGDGE Molecular Weight on H₂ Permeability

In another set of experiments, the effect of the molecular weight of PEGDGE on the crystallinity and the permeability of the resultant crosslinked polyhydroxy polymer was tested. The methodology afore-described in Example 1 was used, except that the molecular weight of the PEGDGE was altered and the final PVA concentration was 7 wt %. An experiment in which PVA was crosslinked with EGDGE was also performed, EGDGE being the shortest monomer unit of the PEGDGE copolymer. The data was compared to a coating prepared without crosslinking (pure PVA). In all experiments, the ratio of hydroxyl groups in the PVA to PEGDGE (or EGDGE) was 30:1, the PVA molecular weight was 146,000-186,000 g/mol and a KOH concentration of 3 wt. % was used. Table 4 summarises the hydrogen permeability results.

TABLE 4
Hydrogen permeability for crosslinked PVA/PEGDGE polymers
as a function of PEGDGE molecular weight.

| PEGDGE molecular | H₂ permeability | |
|---|---|---|
| weight (g/mol) | (Barrer) | Crystallinity (%) |
| — | 0.008 ± 0.0007 | 86.3 |
| 174 (EGDGE) | 0.010 ± 0.002 | 85.8 |
| 500 | 0.011 ± 0.001 | 84.1 |
| 2,000 | 0.13 ± 0.007 | 64.5 |

Pure PVA had the lowest hydrogen permeability (0.008 Barrer) among all tested films. The hydrogen permeability of crosslinked polymer films increased as the molecular weight of the PEGDGE was increased.

For the same molecular weight PVA (146,000-186,000 g/mol), films formed from a composition comprising PEGDGE with a lower molecular weight (500 g/mol) as a crosslinker had lower hydrogen permeability of 0.011 Barrer compared with films formed from compositions comprising PEGDGE with a higher molecular weight (2,000 g/mol), which had a hydrogen permeability of 0.13 Barrer. Films formed from a composition in which the monomer EGDGE was crosslinked with PVA had the lowest hydrogen permeability of 0.010 Barrer. This indicated that the hydrogen permeability was sensitive to changes in crosslinker molecular weight, with the coating formed from a composition produced using 2,000 g/mol PEGDGE having a hydrogen permeability an order of magnitude greater than the coating formed from a composition produced using EGDGE.

It was also observed that the crystallinity decreased as the PEGDGE molecular weight increased. This further supported the idea that the hydrogen permeability was linked to the crystallinity of the coating, with more crystalline coatings tending to have lower hydrogen permeabilities.

It was postulated that the increase in permeability with crosslinker molecular weight was due to crosslinkers with shorter chains having less influence on the crystallinity of fabricated films. In particular, crosslinkers with longer polymer chains were thought to have greater influence on the distance between hydroxyl groups within the polymer. It was thought this affected the inter- and intra-molecular interactions, specifically weakening the inter- and intra-molecular interactions, thus decreasing the polymer crystallinity.

### Example 8—Effect of PEGDGE Molecular Weight on Composition Rheology

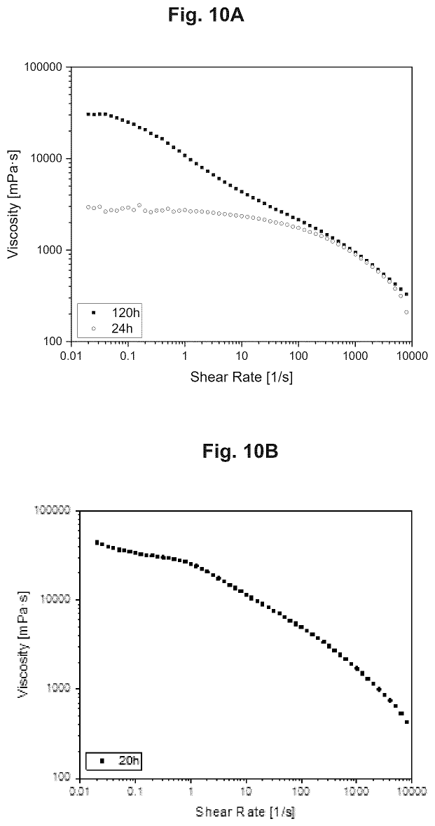

In this set of experiments the effect of the PEGDGE molecular weight on the rheology of the resultant composition was studied. In particular, the rheology of two coating compositions, one in which PVA was crosslinked with the monomer EGDGE, and another in which PVA was crosslinked with PEGDGE with molecular weights of 500 g/mol and 2,000 g/mol were studied. In all cases, the EGDGE or PEGDGE was crosslinked with PVA with a molecular weight of 146,000-186,000 g/mol, the ratio of PVA hydroxyl groups to PEGDGE (or EGDGE) was 30:1, the final PVA concentration was 7 wt. % and a KOH concentration of 3 wt. % was used. Rheology measurement results are presented in FIGS. 10A and 10B for coating compositions formed using EDGE and 2,000 g/mol PEGDGE respectively.

It was observed that samples with a higher molecular weight of PEGDGE could reach the desired viscosity in the low shear rate region in a shorter reaction time. For example, when PEGDGE with a molecular weight of 2,000 g/mol was crosslinked with PVA, the composition achieved a viscosity of 40,000 mPa·s at a shear rate of 0.02 s⁻¹ after 20 h. On the other hand, compositions formed by crosslinking PVA with EGDGE (with a molecular weight of 174 g/mol) only exhibited a viscosity of 3,000 mPa·s at a shear rate of 0.02 s⁻¹ after 24 h. It was observed that this composition exhibited higher viscosities of about 30,000 mPa·s at a shear rate of 0.02 s⁻¹ only after a reaction time of 120 h. Similarly, compositions formed by crosslinking PVA with PEGDGE with a molecular weight of 500 g/mol (FIG. 9B) only exhibited a viscosity of 3,000 mPa·s at a shear rate of 0.02 s⁻¹ after 21 h, with the viscosity increasing to 20,000 mPa·s after 72 h. Therefore, when a lower molecular weight PEGDGE (or EGDGE) crosslinker was reacted with PVA, a longer reaction time was required for the composition to achieve the desired rheological properties.

All compositions were observed to exhibit shear-thinning properties, with the viscosity of all compositions decreasing to around 200 mPa·s at a shear rate of 10,000 s¹. Therefore, all compositions were suitable for use as a coating composition.

### Example 9—Effect of Catalyst on Rheology and Permeability

In this set of experiments, the effect of different catalysts on the rheology of the coating composition and the hydrogen permeability of the coating was studied. The methodology afore-described in Example 1 was used. In all experiments the EGDGE monomer was used. The ratio of PVA hydroxyl groups to EGDGE was 30:1, the PVA molecular weight was 146,000-186,000 g/mol, the final PVA concentration was 7 wt. %, and the concentration of catalyst was 3 wt. %. Two different catalysts were trialled: NaOH and triethyl amine (Et₃N). The results from these experiments were compared to the previous experiments in which KOH was used as the catalyst. Table 5 summarises the hydrogen permeability of the coatings formed from coating compositions in which these different catalysts were used.

TABLE 5
Hydrogen permeability for coatings formed from crosslinked
PVA/EGDGE polymers as a function of catalyst type.

| | H₂ permeability | |
|---|---|---|
| Catalyst | (Barrer) | Crystallinity (%) |
| KOH | 0.010 ± 0.002 | 85.8 |
| Et₃N | 0.011 ± 0.001 | 86.5 |

It was observed that changing the catalyst from KOH to triethyl amine did not significantly affect the hydrogen permeability or the crystallinity of the coating. For example, the hydrogen permeability of the coating was 0.010 Barrer when KOH was the catalyst compared to 0.011 Barrer when triethyl amine was the catalyst. This indicated that KOH could be substituted for other catalysts, including weak bases.

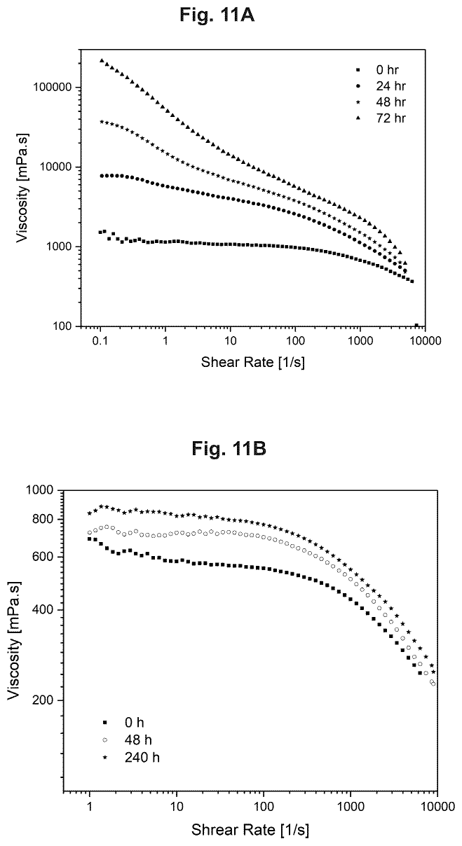

FIGS. 11A and 11B show the rheology measurements for coating compositions formed using NaOH and triethyl amine as the catalysts respectively after different reaction times. It was observed that the crosslinking reaction of PVA and EGDGE in the presence of an NaOH catalyst reached the higher viscosities in the low shear region within shorter reaction times. For example, the coating composition comprising a NaOH catalyst exhibited a viscosity of 6,000 mPa·s at a shear rate of 0.1 s⁻¹ within 24 hrs, whereas coating compositions comprising KOH and triethyl amine catalysts exhibited lower viscosities of 2,700 and 700 mPa·s respectively at a shear rate of 1 s⁻¹.

It was also observed that, when NaOH was used as the catalyst, the coating composition exhibited a viscosity of 200,000 mPa·s at a shear rate of 0.1 s⁻¹ after 72 h reaction time. On the other hand, when KOH was used as the catalyst, the coating composition exhibited a viscosity of 30,000 mPa·s at a shear rate of 0.1 s⁻¹ after 120 h reaction time. When triethyl amine was used as the catalyst, the coating composition exhibited an even lower viscosity of 900 mPa·s at a shear rate of 1 s⁻¹ were after 240 h.

It was observed that crosslinked polyhydroxy polymer compositions prepared using NaOH as a catalyst were suitable for use as a coating composition because they exhibited the desired rheological properties, i.e. shear-thinning behaviour. However, under the selected experimental conditions, compositions prepared using triethyl amine as a catalyst were not suitable for use a coating composition because they did not have the required viscosity in the low shear region, even after reaction times of 240 h.

### Example 10—Effect of PVA Concentration and Catalyst on Reaction Rate

In this set of experiments the effect of the final concentration of the PVA in the coating composition and the concentration of the catalyst on the reaction rate was studied. In these experiments, the PVA concentration in the coating composition was 10 wt. % (compared to 7 wt. %. used in each of the previous Examples in which PVA with a molecular weight of 146,000-186,000 g/mol was used). The molar ratio of hydroxyl groups to EGDGE was 30:1, the PVA molecular weight was 146,000-186,000 g/mol. The concentration of catalyst was reduced to 0.3 wt. %. Two catalysts were trialled: NaOH and ammonium hydroxide (NH₄OH).

TABLE 6
Hydrogen permeability for coatings formed from crosslinked
PVA/EGDGE polymers as a function of catalyst type.

| | H₂ permeability | |
|---|---|---|
| Catalyst | (Barrer) | Crystallinity (%) |
| NaOH | 0.013 ± 0.001 | 86.6 |
| NH₄OH | 0.010 ± 0.001 | 86.6 |

It was observed that changing the catalyst from KOH to NaOH or NH₄OH did not significantly affect the hydrogen permeability or the crystallinity of the resultant coating. Again, this indicated that different strong and weak base catalysts could be used in the preparation of the coating. Similarly, the combined reduction in catalyst concentration and increase in PVA concentration did not affect the hydrogen permeability or the crystallinity.

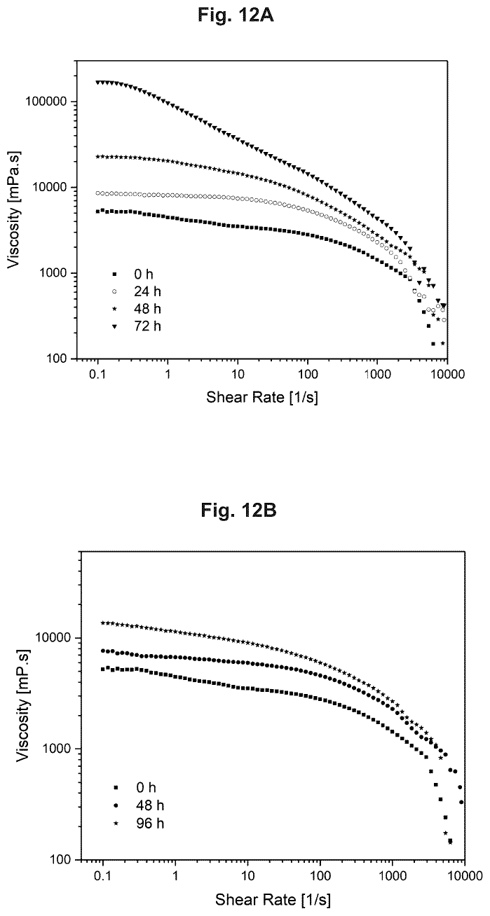

FIG. 12A shows the rheological measurements of the coating composition prepared using NaOH as the catalyst after different reaction times. FIG. 12B shows the rheological measurements of the coating composition prepared using NH₄OH as the catalyst after different reaction times.

It was noted that the time required to reach a high viscosity at a low shear rate was faster using NaOH as a catalyst, compared with using KOH as a catalyst. Specifically, the coating composition prepared using 3 wt. % KOH and 7 wt. % PVA exhibited viscosities of about 30,000 mPa·s at a shear rate of 0.02 s⁻¹ only after a reaction time of 120 h. In contrast, the coating composition prepared using 0.3 wt. % NaOH and 10 wt. % PVA reached 23,000 mPa·s after 48 h at a shear rate of 0.1 s⁻¹ and 170,000 mPa·s after 72 h.

The coating composition prepared using NH₄OH as a catalyst also exhibited shear-thinning behaviour. For example, after 96 h, the coating composition had a viscosity of around 13,000 mPa·s at a shear rate of 0.1 s⁻¹. However, the coating composition showed less shear thinning behaviour compared to the coating compositions prepared using NaOH or KOH catalysts.

By increasing the final PVA concentration from 7 wt. % to 10 wt. %, the concentration of the catalyst could be reduced, e.g. down to 0.3 wt. %. The reduction in concentration of the catalyst reduced the alkalinity of the coating composition. It was thought that this may be advantageous because a reduction in alkalinity of the coating composition could reduce the risk of corrosion when the coating is applied, e.g. to steel pipes.

It was also noted that this showed that compositions formed using strong or weak bases may be suitable for use as a coating composition. However, the strength of the catalyst affected the reaction time required for the coating composition to achieve the desired rheological properties, i.e. shear-thinning behaviour. In particular, the use of weaker bases as the catalyst will tend to increase the reaction time required for the coating composition to achieve a viscosity in the low shear region which enables application of the coating composition to a surface, e.g. by spraying or painting. However, the use of a weaker base as a catalyst may be advantageous in applications where the coating composition is sold as a prepared composition and/or where a long pot life is required. For instance, when the coating composition is being used in a remote location, it can be useful to supply a coating composition with a long pot life.

Variations and modifications may be made to the parts previously described without departing from the spirit or ambit of the disclosure.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that the prior art forms a part of the common general knowledge in the art, in Australia or any other country.

1. A coating composition for forming a hydrogen-barrier coating on a surface, said coating composition comprising:
a crosslinked polyhydroxy polymer, said crosslinked polyhydroxy polymer obtained by reacting a polyhydroxy polymer with a hydroxyl-reactive crosslinking agent; and
a carrier,
wherein the coating composition exhibits shear-thinning behaviour.

2. A coating composition according to claim 1, wherein the shear-thinning behaviour is such that said coating composition has:
a first viscosity of about 10,000 mPa·s to about 100,000 mPa·s under a shear rate of about 0.1 s⁻¹, and
a second viscosity of less than 1000 mPa·s under a shear rate of about 10,000 s⁻¹.

3. A coating composition according to claim 1 or 2, wherein the polyhydroxy polymer is selected from the group consisting of: partially hydrolysed poly(vinyl alcohol); fully hydrolysed poly(vinyl alcohol); and poly(vinyl alcohol) copolymer.

4. A coating composition according to any one of the preceding claims, wherein the polyhydroxy polymer has a number average molecular weight (Mn) of about 30,000 g/mol to about 500,000 g/mol.

5. A coating composition according to any one of the preceding claims, wherein the hydroxyl-reactive crosslinking agent is a diepoxide crosslinking agent.

6. A coating composition according to claim 5, wherein said diepoxide crosslinking agents is vinylcyclohexene dioxide, butadiene dioxide, or a diglycidyl ether.

7. A coating composition according to claim 6, wherein the diglycidyl ether is selected from the group consisting of glycerol diglycidyl ether, 1,4-butanediol diglycidyl ether, ethylene glycol diglycidyl ether, isosorbide diglycidyl ether and poly(ethylene glycol) diglycidyl ether (PEGDGE).

8. A coating composition according to claim 6 or 7, wherein the diglycidyl ether has a molecular weight of about 174 g/mol to about 6000 g/mol.

9. A coating composition according to any one of the preceding claims, wherein the mole ratio of the hydroxyl groups in the polyhydroxy polymer to hydroxyl-reactive groups of the hydroxyl-reactive crosslinking agent is about 50:2 to 5:2.

10. A coating composition according to any one of the preceding claims, wherein the carrier is selected from the group consisting of water, ethanol and combinations thereof.

11. A coating composition according to any one of the preceding claims, wherein the crosslinked polyhydroxy polymer comprises less than about 20% by weight of the coating composition.

12. A hydrogen-barrier coating formed from the coating composition according to any one of claims 1 to 11.

13. A hydrogen-barrier coating according to claim 12, having a hydrogen gas permeability of less than about 0.04 Barrer.

14. A hydrogen-barrier coating according to any one of claims 11, 12 or 13, wherein said hydrogen-barrier coating is on a metallic surface.

15. A hydrogen-barrier coating according to claim 14, wherein the metallic surface is part of an interior surface of a pipe or storage vessel.

16. A method for preventing or reducing exposure of a surface to hydrogen from a hydrogen gas-containing environment, said method comprising:
applying the coating composition according to any one of claims 1 to 11 to the surface; and
drying said coating composition to form a hydrogen-barrier coating, wherein the hydrogen-barrier coating prevents or reduces exposure of the surface to hydrogen from the hydrogen gas-containing environment.

17. A method according to claim 16, wherein applying the coating comprises applying multiple layers of the coating to the surface, permitting each layer to dry before a next layer is applied, so as to achieve a desired thickness.

18. A method according to claim 16 or 17, wherein said surface is a metallic surface.

19. A method according to claim 16, 17 or 18, wherein the surface is part of an interior surface of a pipe or a storage vessel.

20. A coating composition for forming a hydrogen-barrier coating on a metallic surface, said coating composition comprising:
a crosslinked poly(vinyl alcohol) polymer, said crosslinked poly(vinyl alcohol) polymer obtained by reacting a poly(vinyl alcohol) polymer with a diepoxide crosslinking agent; and
a carrier.

21. A coating composition according to claim 20, wherein the poly(vinyl alcohol) polymer polymer is selected from the group consisting of: partially hydrolysed poly(vinyl alcohol); fully hydrolysed poly(vinyl alcohol); and poly(vinyl alcohol) copolymer.

22. A coating composition according to claim 20 or claim 21, wherein the poly(vinyl alcohol) polymer has a number average molecular weight (Mn) of about 30,000 g/mol to about 500,000 g/mol.

23. A coating composition according to claim 20, 21 or 22, wherein said diepoxide crosslinking agent is vinylcyclohexene dioxide, butadiene dioxide, or a diglycidyl ether.

24. A coating composition according to claim 23, wherein the diglycidyl ether is selected from the group consisting of glycerol diglycidyl ether, 1,4-butanediol diglycidyl ether, ethylene glycol diglycidyl ether, isosorbide diglycidyl ether and poly(ethylene glycol) diglycidyl ether (PEGDGE).

25. A coating composition according to claim 23 or 24, wherein the diglycidyl ether has a molecular weight of about 174 g/mol to about 6000 g/mol.

26. A coating composition according to any one of claims 20 to 25, wherein the mole ratio of the hydroxyl groups in the poly(vinyl alcohol) polymer to the diepoxide crosslinking agent is about 50:1 to 10:1.

27. A coating composition according to any one of claims 20 to 26, wherein the carrier is selected from the group consisting of water, ethanol and combinations thereof.

28. A coating composition according to any one of claims 20 to 27, wherein the crosslinked poly(vinyl alcohol) polymer comprises less than about 20% by weight of the coating composition.

29. A hydrogen-barrier coating formed from the coating composition according to any one of claims 20 to 28.

30. A hydrogen-barrier coating according to claim 29, having a hydrogen gas permeability of less than about 0.04 Barrer.

31. A hydrogen-barrier coating according to claim 30, wherein the hydrogen-barrier coating is on a surface comprising part of an interior surface of a pipe or a storage vessel.

32. A method for preventing or reducing exposure of a surface to hydrogen from a hydrogen gas-containing environment, said method comprising:
applying the coating composition according to any one of claims 20 to 28 to the surface; and
drying said coating composition to form a hydrogen-barrier coating, wherein the hydrogen-barrier coating prevents or reduces exposure of the surface to hydrogen from the hydrogen gas-containing environment.

33. A method according to claim 32, wherein applying the coating comprises applying multiple layers of the coating to the surface, permitting each layer to dry before a next layer is applied, so as to achieve a desired thickness.

34. A method according to claim 32 or 33, wherein the surface is part of an interior surface of a pipe or a storage vessel.

35. A kit for preparing a coating composition in accordance with any one of claims 1 to 11, said kit comprising the polyhydroxy polymer and the hydroxyl-reactive crosslinking agent.

36. A kit for preparing a coating composition in accordance with any one of claims 20 to 28, said kit comprising the poly(vinyl alcohol) polymer and the diepoxide crosslinking agent.

37. A precursor composition for forming a coating composition, said precursor composition comprising:
a poly(vinyl alcohol) polymer;
a diepoxide crosslinking agent; and
a carrier.

38. A precursor composition according to claim 37, further comprising a catalyst.

39. A precursor composition according to claim 37 or 38, wherein the coating composition is a coating composition according to any one of claims 1 to 11 and 20 to 28.
